(19) United States
(12) Patent Application Publication
(10) Pub. No.: US 2007/0261068 A1
(43) Pub. Date: Nov. 8, 2007

(54) Optical recording medium

(75) Inventors: Masafumi Yoshihiro, Ibaraki-shi (JP); Osamu Ishizaki, Ibaraki-shi (JP); Toshinori Sugiyama, Ibaraki-shi (JP); Yoshiyuki Nagataki, Ibaraki-shi (JP); Hironori Ota, Ibaraki-shi (JP)

Correspondence Address: OLIFF & BERRIDGE, PLC, P.O. BOX 19928, ALEXANDRIA, VA, 22320, US

(73) Assignee: Hitachi Maxell, Ltd., Ibaraki-shi (JP)

(21) Appl. No.: 11/236,840

(22) Filed: Sep. 28, 2005

(30) Foreign Application Priority Data
Sep. 30, 2004 (JP) 2004-285758

(51) Int. Cl. G11B 7/24

(52) U.S. Cl. 720/718

(57) ABSTRACT

An optical recording medium having two information sections (L0 and L1 layers) is provided by holding relationships:
R1≧R3+r
R2≦R4−r
wherein R1, R2, R3, and R4 represent distances from the center of the medium at radial positions: R of an innermost circumferential track of a test area disposed on an inner circumferential side of the L1 layer; R of an outermost circumferential track of a test area disposed on an outer circumferential side of the L1 layer; R of an innermost circumferential guide groove of an information-recording area of the L0 layer; and R of an outermost circumferential guide groove of the information-recording area of the L0 layer respectively, and r represents a radius of a light beam on the L0 layer when the light beam is collected on the L1 layer.

### BACKGROUND OF THE INVENTION

1. Field of the Invention

The present invention relates to an optical recording medium. In particular, the present invention relates to an optical recording medium having two or more layers of information sections each of which is provided with a substrate and a recording layer, wherein at least one of the information sections includes a ROM area in which information is previously preformatted on the substrate, and an information-recording area in which information is to be written additionally.

2. Description of the Related Art

A variety of optical disks of the read-only type, the write-once type, and the rewritable type are widely used as the optical recording medium. In particular, DVD-ROM (read-only type), DVD-R (write-once type), and DVD-RAM (rewritable type) are well-known. Of the optical disks as described above, for example, the method for producing DVD-R is as follows. At first, a light-transmissive disk-shaped substrate having a thickness of 0.6 mm is coated with an organic dye material to form a recording layer, and then a light-reflective layer is stacked on the recording layer to manufacture a disk (recording disk). The recording disk of DVD-R has a recording capacity of 4.7 GB. Subsequently, the recording disk is stuck to a dummy which has a thickness of 0.6 mm and on which the writing cannot be performed. In this way, DVD-R of the single-sided recording type having the recording capacity of 4.7 GB is manufactured.

On the other hand, DVD-R of the double-sided recording type having a recording capacity of 9.4 GB is also known, in which two recording disks each having a recording capacity of 4.7 GB are stuck to one another. In the case of DVD-R of the double-sided recording type, the laser beam is radiated from the both sides to record and reproduce information. DVD-R of the double-sided recording type has the recording capacity of 9.4 GB which is large. However, when information is recorded and reproduced on the recording disk on the reverse side, it has been necessary that the disk should be reversed upside down, because the laser beam is radiated from the both sides to record and reproduce information.

Recently, an optical disk (optical disk of the single-sided two-layered type) has been proposed, for example, in Japanese Patent Application Laid-open No. 11-66622, in which the laser beam is radiated, from only one side of the optical disk, onto the optical disk including two stuck recording disks, wherein information can be recorded on both of the recording disks. Actually, an optical disk of the single-sided two-layered type having a recording capacity of 8.5 GB has been developed, which is progressively spread in the market.

### SUMMARY OF THE INVENTION

The optical disk of the single-sided two-layered type as described above has such a structure that a first recording disk (hereinafter referred to as “first information section” as well), a spacer layer, and a second recording disk (hereinafter referred to as “second information section” as well) are provided in this order from the light beam-incoming side. When information is recorded and reproduced on the second information section, the light beam is radiated onto the second information section via the first information section and the spacer layer.

However, in the case of the optical disk of the single-sided two-layered type, the substrate of the first information section is formed with areas having different substrate shapes including, for example, a specular or mirror surface section and a preformatted information area. Therefore, the light transmittance of the light beam transmitted through the first information section differs between the respective areas having the different shapes formed on the substrate of the first information section. Further, the light transmittance of the light beam transmitted through the first information section also differs, for example, between the information-recording area which has not been recorded in the recording layer of the first information section and the information-recording area which has been recorded. That is, the light transmittance of the light beam transmitted through the first information section differs depending on the shape of the substrate in the first information section and the recording state of the recording layer. For this reason, when information is recorded or reproduced on the second information section of the optical disk of the single-sided two-layered type, if the light beam passes through the areas having the different light transmittances of the first information section, then the radiation light amount of the light beam to arrive at the second information section is consequently changed, even when the amount of light radiated from the optical head is constant.

The variation of the light amount of the light beam to arrive at the second information section as described above cannot be detected with any value other than the amount of reflected light from the second information section. Therefore, it is possible to respond to the variation or fluctuation of the light amount by performing AGC (Auto Gain Control) for the reproduced signal from the second information section. However, the light intensity distribution becomes nonuniform in the light beam. Therefore, any offset arises in relation to the focus error signal and the tracking error signal. Such an offset exerts a certain harmful influence which is greater than the influence exerted by the fluctuation of the light amount of the light beam on the quality of the reproduced signal obtained from the second information section, which causes any error in the reproduction of information. In some cases, it is impossible to maintain the tracking control and/or the focus control during the recording and reproduction on the second information section.

Further, the fluctuation of the light amount of the light beam to arrive at the second information section exerts the following lethal influence during the recording of information. When the recording power is set for the second information section with the light beam which passes through the area of the first information section in which the light transmittance is high, then the recording power of the light beam is subjected to the power shortage, and any large asymmetry possibly arises in the signal in the area of the second information section which is irradiated with the light beam passing through the area of the first information section in which the light transmittance is low. In the case of the opposite condition, i.e., when the recording power is set for the second information section with the light beam which passes through the area of the first information section in which the light transmittance is low, the signal is subjected to the writing with any overpower in the area of the second information section which is irradiated with the light beam passing through the area of the first information section in which the light transmittance is high. Therefore, any cross-write (signal of the adjoining track is subjected to the overwriting) possibly arises. Further, if the light transmittance of the light beam is fluctuated during the test for determining the recording power for the second information section, the determination of the recording power is affected by both of the fluctuation of the recording light amount and the fluctuation of the reproducing amplitude. Therefore, the test operation comes to an end while unsuccessfully determining the recording power. It is feared that the recording cannot be performed over the entire second information section.

The present invention has been made in order to solve the problems as described above. An object of the present invention is to provide an optical recording medium having two or more information sections, wherein information can be recorded and reproduced stably and highly reliably on the information section disposed on the side far from the light-incoming side.

According to an aspect of the present invention, there is provided an optical recording medium on which information is recorded and reproduced by being irradiated with a light beam, the optical recording medium comprising:

a first information section which includes a first substrate and a first recording layer and into which the light beam comes from a side of the first substrate; and

a second information section which includes a second substrate and a second recording layer and in which the second recording layer is arranged on a side of the first recording layer of the first information section, wherein:

the first information section has a first preformat area and a first information-recording area, emboss pits are provided in an area on the first substrate corresponding to the first preformat area, and a guide groove for the light beam is provided in an area on the first substrate corresponding to the first information-recording area;

the second information section has a second information-recording area and a test area which is included in at least one of a portion disposed in the vicinity of an inner circumference and a portion disposed in the vicinity of an outer circumference in the second information-recording area and which is usable to determine a recording condition when information is recorded, and a guide groove for the light beam is provided in an area on the second substrate corresponding to the second information-recording area; and

an area of the first information section which corresponds to the test area of the second information section is included in the first information-recording area of the first recording section.

In the optical recording medium of the present invention, the following expression (1) may hold when the test area is provided at the portion disposed in the vicinity of the inner circumference of the second information-recording area:
R1≧R3+r (1); and

the following expression (2) may hold when the test area is provided at the portion disposed in the vicinity of the outer circumference of the second information-recording area:
R2≦R4−r (2)

wherein R1, R2, R3, and R4 represent distances from a center of the optical recording medium at a radial position of an innermost circumferential track of the test area when the test area is provided at the portion in the vicinity of the inner circumference of the second information-recording area, a radial position of an outermost circumferential track of the test area when the test area is provided at the portion in the vicinity of the outer circumference of the second information-recording area, a radial position of an innermost circumferential guide groove of the first information-recording area, and a radial position of an outermost circumferential guide groove of the first information-recording area respectively, and r represents a radius of the light beam on the first information section when the light beam is collected on the second information section.

In the optical recording medium of the present invention, when the test area is provided at each of the portions disposed in the vicinity of the inner circumference and the outer circumference of the second information-recording area, both of the expressions (1) and (2) may hold. The optical recording medium of the present invention may further comprise a spacer layer which is disposed between the first information section and the second information section.

FIG. 4 shows an example of the positional relationships of the physical formats between the first information section and the second information section in the optical recording medium of the present invention. The example shown in FIG. 4 is illustrative of the optical recording medium of the present invention as constructed when the test areas are provided at the portion disposed in the vicinity of the inner circumference and the portion disposed in the vicinity of the outer circumference in the second information-recording area of the second information section. That is, the optical recording medium of the present invention is provided, wherein both of the relationships of the expressions (1) and (2) hold in relation to the radial positions of the respective areas provided that R1, R2, R3, and R4 represent the distances from the center of the optical recording medium at the radial position R (1, TI, i) of the innermost circumferential track of the test area disposed at the portion in the vicinity of the inner circumference of the second information-recording area shown in FIG. 4, the radial position R (1, TO, o) of the outermost circumferential track of the test area disposed at the portion in the vicinity of the outer circumference of the second information-recording area, the radial position R (0, G, i) of the innermost circumferential guide groove in the first information-recording area of the first information section, and the radial position R (0, G, o) of the outermost circumferential guide groove in the first information-recording area of the first information section respectively.

The meanings of the respective parameters in the parentheses of the radial positions R (P1, P2, P3) expressed as described above are as follows. The first parameter P1 indicates any information section of the first information section and the second information section to which the radial position R belongs. This parameter is indicated by “0” in the case of the first information section (L0 layer), and it is indicated by “1” in the case of the second information section (L1 layer). The second parameter P2 indicates any area in the physical format to which the radial position belongs. This parameter is indicated by “TI” in the case of the test area disposed in the vicinity of the inner circumference of the second information-recording area, it is indicated by “TO” in the case of the test area disposed in the vicinity of the outer circumference of the second information-recording area, it is indicated by “G” in the case of the information-recording area (area formed with the groove), and it is indicated by “D” in the case of the information-recording/reproducing area in which user information or the like is to be recorded. The third parameter P3 indicates whether the radial position is the innermost circumferential position or the outermost circumferential position in the area designated by the parameter P2. This parameter is indicated by “i” in the case of the innermost circumferential position, and it is indicated by “o” in the case of the outermost circumferential position.

FIG. 4 shows schematic structural sectional views taken in the radial direction illustrating the respective physical formats of the first information section 10 (hereinafter referred to as “L0 layer” as well) and the second information section 20 (hereinafter referred to as “L1 layer” as well) adjoining to one another with the spacer layer 30 (adhesive layer) intervening therebetween. The direction, which is directed from the left side to the right side in the drawing, is the outer circumferential direction of the optical recording medium. In the example shown in FIG. 4, the physical format of the L0 layer 10 is constructed by a preformat area 51 (ROM area), a transition area 52 (mirror area), an information-recording area 50, and a mirror area 58 from the inner circumferential side of the optical recording medium. As shown in FIG. 4, the information-recording area 50 of the L0 layer 10 is constructed by two buffer areas 53, 57, two test areas 54, 56, and an information-recording/reproducing area 55. The test areas 54, 56 are provided in the vicinity of the inner circumference and the outer circumference of the information-recording area 50 respectively. In the example shown in FIG. 4, the L1 layer 20 also has the same or equivalent physical format structure as that of the L0 layer 10.

FIG. 4A shows the positional relationship of the physical formats between the L0 layer 10 and the L1 layer 20 when the lower limit condition of the expression (1) (relationship of R1=R3+ r) holds with respect to the radial position R (1, TI, i) of the innermost circumferential track in the test area 64 on the inner circumferential side of the L1 layer 20. On the other hand, FIG. 4B shows the positional relationship of the physical formats between the L0 layer 10 and the L1 layer 20 when the upper limit condition of the expression (2) (relationship of R2=R4−r) holds with respect to the radial position R (1, TO, o) of the outermost circumferential track in the test area 66 on the outer circumferential side of the L1 layer 20. Usually, when the L0 layer 10 and the L1 layer 20 are stuck to one another, any eccentricity arises. FIG. 4 shows an exemplary situation in which the outer circumferential ends of the L0 layer 10 and the L1 layer 20 are deviated from each other by a specification value RRₚ₋ₚ (PEAK TO PEAK value) of the eccentricity amount.

In the case of the optical recording medium in which the relationship of the radial positions as shown in FIG. 4A holds between the physical format of the L0 layer 10 and the physical format of the L1 layer 20, the relationship of R1=R3+r (relationship of the expression (1)) holds for the radial position R (1, TI, i) of the innermost circumferential track of the test area 64 on the inner circumferential side of the L1 layer 20. Therefore, as shown in FIG. 4A, even when the light beam 40 is collected on the position R (1, TI, i) of the innermost circumferential track of the test area 64, the light beam 40 does not pass through the transition area 52 and the preformat area 51 of the L0 layer 10.

As clarified from FIG. 4A, the relationship of R2<R4−r (relationship of the expression (2)) holds for the radial position R (1, TO, o) of the outermost circumferential track of the test area 66 on the outer circumferential side of the L1 layer 20. Therefore, even when the light beam 40 is collected on the outermost circumferential position R (1, TO, o) of the test area 66 on the outer circumferential side of the L1 layer 20, the light beam 40 does not pass through the mirror area 58 on the outer circumferential side of the L0 layer 10.

On the other hand, in the case of the optical recording medium in which the relationship of the radial positions as shown in FIG. 4B holds between the physical format of the L0 layer 10 and the physical format of the L1 layer 20, the relationship of R2=R4−r (relationship of the expression (2)) holds for the radial position R (1, TO, o) of the outermost circumferential track of the test area 66 on the outer circumferential side of the L1 layer 20. Therefore, as shown in FIG. 4B, even when the light beam 40 is collected on the position R (1, TO, o) of the outermost circumferential track of the test area 66, the light beam 40 does not pass through the mirror area 58 of the L0 layer 10.

As clarified from FIG. 4B, the relationship of R1>R3+r (relationship of the expression (1)) holds for the radial position R (1, TI, i) of the innermost circumferential track of the test area 64 on the inner circumferential side of the L1 layer 20. Therefore, even when the light beam 40 is collected on the innermost circumferential position R (1, TI, i) of the test area 64 on the inner circumferential side of the L1 layer 20, the light beam 40 does not pass through the transition area 52 and the preformat area 51 of the L0 layer 10.

That is, in the case of the optical recording medium in which the relationships of the radial positions (relationships of the expressions (1) and (2)) as shown in FIGS. 4A and 4B hold between the physical format of the L0 layer 10 and the physical format of the L1 layer 20, the light beam, which is collected over the entire region of the test areas 64, 66 and the information-recording/reproducing area 65 of the L1 layer 20, does not pass through the preformat area 51, the transition area 52, and the mirror area 58 of the L0 layer 10, and the light beam passes through only the information-recording area 50. The area on the first substrate, which corresponds to the information-recording area 50 of the L0 layer 10, is the area in which the groove is formed over the entire region (area in which the uniform concave/convex pattern is formed). Accordingly, the light beam 40, which passes through the information-recording area 50 of the L0 layer 10, has the transmittance which is approximately constant over the entire region of the information-recording area 50. Therefore, in the case of the optical recording medium in which the relationships of the radial positions as shown in FIGS. 4A and 4B hold between the physical format of the L0 layer 10 and the physical format of the L1 layer 20, the light beam 40, which is radiated onto the test areas 64, 66 and the information-recording/reproducing area 65 of the L1 layer 20, passes through only the information-recording area 50 of the L0 layer 10 in which the transmittance is approximately constant. Therefore, it is possible to suppress the variation or fluctuation of the light amount of the light beam 40 to arrive at the test areas 64, 66 and the information-recording/reproducing area 65 of the L1 layer 20.

As described above, the relationships of the radial positions represented by the expressions (1) and (2) are held between the physical format of the L0 layer 10 and the physical format of the L1 layer 20 in the optical recording medium having the test areas in the vicinity of the inner circumference and the outer circumference of the second information-recording area of the L1 layer 20. Accordingly, the light beam 40, in which the light amount fluctuation is extremely small, is radiated onto the test areas 64, 66 on the inner circumferential side and the outer circumferential side of the L1 layer 20. Therefore, it is possible to certainly determine the optimum recording power to be used during the recording of information. Further, the light beam, which arrives at the information-recording/reproducing area 65 of the L1 layer 20, undergoes the extremely small light amount fluctuation as well. Accordingly, the user information or the like can be stably recorded with the optimum recording power in the information-recording/reproducing area 65 of the L1 layer 20. Therefore, when the relationships of the radial positions between the physical format of the L0 layer 10 and the physical format of the L1 layer 20 are adjusted so that the relationships of the expressions (1) and (2) hold, information can be recorded and reproduced stably and highly reliably on the information section (L1 layer) disposed on the side far from the incoming side of the light beam 40.

The foregoing explanation has been made about the optical recording medium which has the test areas at both of the portions disposed in the vicinity of the inner circumference and the outer circumference of the second information-recording area of the second information section (L1 layer) disposed on the side far from the incoming side of the light beam. However, the present invention is not limited thereto. When the test area is provided at only the portion disposed in the vicinity of the inner circumference of the second information-recording area of the second information section, it is appropriate that the relationship of the radial positions may be adjusted between the physical format of the second information section and the physical format of the first information section (L0 layer) disposed on the incoming side of the light beam so that only the relationship of the expression (1) holds. When the test area is provided at only the portion disposed in the vicinity of the outer circumference of the second information-recording area of the second information section, it is appropriate that the relationship of the radial positions may be adjusted between the physical format of the second information section and the physical format of the first information section so that only the relationship of the expression (2) holds. In any case, the effect is obtained in the same manner as in the case of the optical recording medium which has the test areas at both of the portions in the vicinity of the inner circumference and the outer circumference of the second information-recording area of the second information section as described above.

In this specification, the phrase “radius r of the light beam on the first information section” refers to the radius of the light beam at the interface between the substrate and the first recording layer of the first information section (L0 layer). The radius r of the light beam on the first information section, which is provided when the light beam is collected on the second information section (L1 layer), is determined as follows according to FIG. 6.

As shown in FIG. 6, it is assumed that D represents the thickness of the spacer layer disposed between the first information section (L0 shown in FIG. 6) and the second information section (L1 shown in FIG. 6), ns represents the refractive index of the spacer layer, and NA represents the numerical aperture of the focusing lens. On this assumption, the radius r of the light beam on the first information section can be determined by the following numerical expression according to the geometrical relationship shown in FIG. 6. However, the solid line L0 shown in FIG. 6 indicates the position of the first recording layer in the first information section, and the solid line L1 indicates the position of the second recording layer in the second information section. In FIG. 6, the thicknesses of the first recording layer and the second recording layer are not taken into consideration, because the film thicknesses of the first and second recording layers are extremely small as compared with the thickness of the spacer layer. For example, in Examples described later on, the film thicknesses of the first and second recording layers have values of less than about 0.4% with respect to the thickness of the spacer layer. Therefore, even when the film thicknesses of the first and second recording layers are not taken into consideration when the radius r of the light beam on the first information section is calculated, no great influence is exerted on the value of the radius r of the light beam. In Examples described later on, for example, a reflective layer and an interface layer are provided between the recording layer and the spacer layer. However, the film thicknesses of these layers are also extremely small as compared with the thickness of the spacer layer. Therefore, even when the film thicknesses of these layers are not taken into consideration, no great influence is exerted on the value of the radius r of the light beam.

$$\begin{matrix}r = D tan θ \\ = D \frac{sin θ}{cos θ} \\ = D \frac{sin θ}{\sqrt{1 - {sin}^{2} θ}} \\ = D \frac{\frac{NA}{{n}_{s}}}{\sqrt{1 - {[ \frac{NA}{{n}_{s}} ]}^{2}}}\end{matrix} \qquad [ Expression 1 ]$$

The radial positions are set for the physical formats of the respective information sections so that the positional relationship between the physical formats of the first and second information sections of the produced optical recording medium satisfies the expression (1) and/or the expression (2) at the stage at which the optical recording medium of the present invention is designed. However, in such a situation, the optical recording medium may be designed while considering the deviation of the center position due to the eccentricity brought about when the first information section and the second information section are stuck to one another. It is noted that the deviation of the center position between the first information section and the second information section has the maximum value when the eccentricity is caused in the opposite directions with the disk clamp center intervening therebetween.

Specifically, the radial positions of the physical formats of the respective information sections may be designed so that the following expression (1)′ holds:
R1′≧R3′+RRₚ₋ₚ+r (1)
when the test area is provided in the vicinity of the inner circumference of the second information-recording area of the second information section, and the radial positions of the physical formats of the respective information sections may be designed so that the following expression (2)′ holds:
R2′≦R4′+RRₚ₋ₚ−r (2)′
when the test area is provided in the vicinity of the outer circumference of the second information-recording area of the second information section, provided that R1′ and R2′ represent the distances from the center of the second information section at the radial position R (1, TI, i) of the innermost circumferential track of the test area in the vicinity of the inner circumference of the second information-recording area of the second information section and the radial position R (1, TO, o) of the outermost circumferential track of the test area in the vicinity of the outer circumference of the second information-recording area respectively, R3′ and R4′ represent the distances from the center of the first information section at the radial position R (0, G, i) of the innermost circumferential guide groove of the first information-recording area of the first information section and the radial position R (0, G, o) of the outermost circumferential guide groove of the first information-recording area respectively, r represents the radius of the light beam on the first information section when the light beam is collected on the second information section, and RRₚ₋ₚ (PEAK TO PEAK value) represents the specification value of the eccentricity. When the test areas are provided at both of the portions in the vicinity of the inner circumference and the outer circumference of the second information-recording area of the second information section, the radial positions of the physical formats of the respective information sections may be designed so that the expressions (1)′ and (2)′ hold.

When the optical disk of the single-sided two-layered type is actually manufactured, the optical disk is manufactured so that the eccentricity amount is necessarily included in the specification value. Therefore, when the positional relationship of the physical format between the first and second information sections is designed beforehand so that the expression (1)′ and/or the expression (2)′ is satisfied, the relationship of the radial position of the expression (1)′ and/or the expression (2)′ necessarily holds between the physical format of the first information section and the physical format of the second information section of the manufactured optical recording medium.

More practically, the radial position of the physical format of each of the information sections may be established at the designing stage by adding, to the expressions (1)′ and (2)′, the error factors including, for example, the substrate shrinkage or contraction, the deviation from the circularity of the groove accompanied thereby, and the position-setting accuracy of the mastering apparatus.

In the optical recording medium of the present invention, the following expression (3) may hold when the test area is provided at the portion disposed in the vicinity of the inner circumference of the second information-recording area:
R1≧R5+r (3); and

the following expression (4) may hold when the test area is provided at the portion disposed in the vicinity of the outer circumference of the second information-recording area:
R2≦R6−r (4)

wherein R5 and R6 represent distances from the center of the optical recording medium at a radial position of an innermost circumferential track on which information is recorded in the first information-recording area, and a radial position of an outermost circumferential track on which information is recorded in the first information-recording area respectively. Further, when the test areas are provided at both of the portions disposed in the vicinity of the inner circumference and the outer circumference of the second information-recording area, both of the expressions (3) and (4) may hold.

In this specification, the phrase “radial position of an innermost circumferential track on which information is recorded” means the radial position of the innermost circumferential track in the area in which information is written once by the user in the first information-recording area.

The light transmittance of the light beam passing through the first information section is varied or fluctuated depending on the shape of the first substrate of the first information section as described above. Further, the light transmittance is also changed in some cases depending on, for example, the information-recording area not subjected to the recording of the first recording layer of the first information section and the information-recording area after the recording, i.e., the recording state of the first recording layer. For example, when the first recording layer of the first information section is formed of a dye material, the transmittance is consequently changed in some cases before and after the recording of information on the first recording layer. In particular, the fluctuation of the transmittance is more increased in the test area for determining the recording power, because the recording is performed while changing the recording power from a lower recording power to a power larger than the optimum recording power. The trial writing is not necessarily performed over the entire region of the test area. Therefore, the recorded area and the non-recorded area are present in a mixed manner in the test area in some cases. In such a situation, it is feared that the transmittance of the light beam may be also greatly changed in the test area, and the light amount of the light beam to arrive at the second information section may be fluctuated.

When the light amount of the light beam to arrive at the second information section is fluctuated depending on the recording state of the test area of the first information section as described above, it is appropriate that the positional relationship between the physical format of the first information section and the physical format of the second information section is adjusted so that the light beam does not pass through the test area of the first information section when the light beam is radiated onto the information-recording area and the test area of the second information section. The condition, under which the positional relationship as described above is to be satisfied, is the relationship indicated by the expression (3) and/or the expression (4). The expressions (3) and (4) are the conditional expressions provided when the transmittance is fluctuated depending on both of the shape of the first substrate of the first information section and the recording state of the first recording layer. Therefore, the conditional ranges of the expressions (3) and (4) are included in the conditional ranges of the expressions (1) and (2) respectively.

FIG. 5 shows examples of the positional relationships between the physical format of the first information section and the physical format of the second information section brought about when both of the relationships of the expressions (3) and (4) are satisfied. FIG. 5 shows schematic structural sectional views taken in the radial direction illustrating the respective physical formats of the first information section 10 (L0 layer) and the second information section 20 (L1 layer) adjoining to one another with the spacer layer 30 intervening therebetween. The direction, which is directed from the left side to the right side in the drawing, is the outer circumferential direction of the optical recording medium.

FIG. 5A shows the positional relationship of the physical formats between the L0 layer 10 and the L1 layer 20 when the lower limit condition of the expression (3) (relationship of R1=R5+r) holds with respect to the radial position R (1, TI, i) of the innermost circumferential track in the test area 64 on the inner circumferential side of the L1 layer 20. On the other hand, FIG. 5B shows the positional relationship of the physical formats between the L0 layer 10 and the L1 layer 20 when the upper limit condition of the expression (4) (relationship of R2=R6−r) holds with respect to the radial position R (1, TO, o) of the outermost circumferential track in the test area 66 on the outer circumferential side of the L1 layer 20. Usually, when the L0 layer 10 and the L1 layer 20 are stuck to one another, any eccentricity arises. FIG. 5 shows an exemplary situation in which the outer circumferential ends of the L0 layer 10 and the L1 layer 20 are deviated from each other by a specification value RRₚ₋ₚ of the eccentricity amount.

In the case of the optical recording medium in which the relationship of the radial positions as shown in FIG. 5A holds between the physical format of the L0 layer 10 and the physical format of the L1 layer 20, R1=R5+r (relationship of the expression (3)) holds for the radial position R (1, TI, i) of the innermost circumferential track of the test area 64 on the inner circumferential side of the L1 layer 20. Therefore, as shown in FIG. 5A, even when the light beam 40 is collected on the position R (1, TI, i) of the innermost circumferential track of the test area 64 of the L1 layer 20, the light beam 40 does not pass through the test area 54, the transition area 52, and the preformat area 51 of the L0 layer 10.

As clarified from FIG. 5A, the relationship of R2<R6−r (relationship of the expression (4)) holds for the radial position R (1, TO, o) of the outermost circumferential track of the test area 66 on the outer circumferential side of the L1 layer 20. Therefore, even when the light beam 40 is collected on the outermost circumferential position R (1, TO, o) of the test area 66 on the outer circumferential side of the L1 layer 20, the light beam 40 does not pass through test area 56 and the mirror area 58 on the outer circumferential side of the L0 layer 10.

On the other hand, in the case of the optical recording medium in which the relationship of the radial positions as shown in FIG. 5B holds between the physical format of the L0 layer 10 and the physical format of the L1 layer 20, the relationship of R2=R6−r (relationship of the expression (4)) holds for the radial position R (1, TO, o) of the outermost circumferential track of the test area 66 on the outer circumferential side of the L1 layer 20. Therefore, as shown in FIG. 5B, even when the light beam 40 is collected on the position R (1, TO, o) of the outermost circumferential track of the test area 66, the light beam 40 does not pass through the test area 56 and the mirror area 58 on the outer circumferential side of the L0 layer 10.

As clarified from FIG. 5B, the relationship of R1>R5+r (relationship of the expression (3)) holds for the radial position R (1, TI, i) of the innermost circumferential track of the test area 64 on the inner circumferential side of the L1 layer 20. Therefore, even when the light beam 40 is collected on the innermost circumferential position R (1, TI, i) of the test area 64 on the inner circumferential side of the L1 layer 20, the light beam 40 does not pass through the test area 54, the transition area 52, and the preformat area 51 on the inner circumferential side of the L0 layer 10.

That is, in the case of the optical recording medium in which the relationships of the radial positions (relationships of the expressions (3) and (4)) as shown in FIGS. 5A and 5B hold between the physical format of the L0 layer 10 and the physical format of the L1 layer 20, the light beam, which is collected over the entire region of the test areas 64, 66 and the information-recording/reproducing area 65 of the L1 layer 20, does not pass through the preformat area 51, the transition area 52, the mirror area 58, and the test areas 54, 56 of the L0 layer 10, and the light beam passes through only the information-recording/reproducing area 55 of the L0 layer 10. The groove is formed over the entire region of the information-recording/reproducing area 55 of the L0 layer 10, and information is recorded at a predetermined recording power. Usually, information is recorded from the L0 layer 10. Therefore, a state is given at the point of time at which information is recorded on the L1 layer 20, in which the user information or the like is uniformly recorded in the entire region of the information-recording/reproducing area 55 of the L0 layer 10. Accordingly, the light beam 40, which passes through the information-recording/reproducing area 55 of the L0 layer 10, has the transmittance which is approximately constant. Therefore, in the case of the optical recording medium in which the relationships of the radial positions as shown in FIGS. 5A and 5B hold between the physical format of the L0 layer 10 and the physical format of the L1 layer 20, the light beam 40, which is radiated onto the test areas 64, 66 and the information-recording/reproducing area 65 of the L1 layer 20, passes through only the information-recording/reproducing area 55 of the L0 layer 10 in which the transmittance is approximately constant, even when the light transmittance is fluctuated depending not only on the shape of the first substrate of the L0 layer 10 but also on the recording states of the test areas 54, 56. Therefore, it is possible to suppress the variation or fluctuation of the light amount of the light beam 40 which arrives at the test areas 64, 66 and the information-recording/reproducing area 65 of the L1 layer 20.

As described above, in the case of the optical recording medium in which the relationships of the radial positions represented by the expressions (3) and (4) hold between the physical format of the L0 layer 10 and the physical format of the L1 layer 20, the light beam 40, in which the light amount fluctuation is extremely small, is radiated onto the test areas 64, 66 on the inner circumferential side and the outer circumferential side of the L1 layer 20, even when the light transmittance is fluctuated depending not only on the shape of the first substrate of the L0 layer 10 but also on the recording states of the test areas 54, 56. Therefore, it is possible to certainly determine the optimum recording power to be used during the recording of information. Further, the light beam, which arrives at the information-recording/reproducing area 65 of the L1 layer 20, undergoes the extremely small light amount fluctuation as well. Accordingly, the user information or the like can be stably recorded with the optimum recording power in the information-recording/reproducing area 65 of the L1 layer 20. Therefore, when the light transmittance is fluctuated depending on the shape of the first substrate and the recording state of the test area of the L0 layer 10, then the relationships of the radial positions between the physical format of the L0 layer 10 and the physical format of the L1 layer 20 are adjusted so that the relationships of the expressions (3) and (4) hold, and thus information can be recorded and reproduced stably and highly reliably on the information section (L1 layer) disposed on the side far from the incoming side of the light beam 40.

The foregoing explanation has been made about the optical recording medium which has the test areas at both of the portions disposed in the vicinity of the inner circumference and the outer circumference of the second information-recording area of the second information section (L1 layer) disposed on the side far from the incoming side of the light beam. However, the present invention is not limited thereto. When the test area is provided at only the portion disposed in the vicinity of the inner circumference of the second information-recording area of the second information section, it is appropriate that the relationship of the radial positions may be adjusted between the physical format of the second information section and the physical format of the first information section (L0 layer) disposed on the incoming side of the light beam so that only the relationship of the expression (3) holds. When the test area is provided at only the portion disposed in the vicinity of the outer circumference of the second information-recording area of the second information section, it is appropriate that the relationship of the radial positions may be adjusted between the physical format of the second information section and the physical format of the first information section so that only the relationship of the expression (4) holds. In any case, the effect is obtained in the same manner as in the case of the optical recording medium which has the test areas at both of the portions in the vicinity of the inner circumference and the outer circumference of the second information-recording area of the second information section as described above.

When the optical recording medium of the present invention, in which the relationship of the expression (3) and/or the expression (4) holds, is designed, the optical recording medium may be designed while considering the deviation of the center position due to the eccentricity brought about when the first information section and the second information section are stuck to one another.

Specifically, the radial positions of the physical formats of the respective information sections may be designed so that the following expression (3)′ holds:
R1′≧R5′+RRₚ₋ₚ+r (3)′
when the test area is provided in the vicinity of the inner circumference of the second information-recording area of the second information section, and the radial positions of the physical formats of the respective information sections may be designed so that the following expression (4)′ holds:
R2′≦R6′+RRₚ₋ₚ−r (4)′
when the test area is provided in the vicinity of the outer circumference of the second information-recording area of the second information section, provided that R1′ and R2′ represent the distances from the center of the second information section at the radial position R (1, TI, i) of the innermost circumferential track of the test area in the vicinity of the inner circumference of the second information-recording area of the second information section shown in FIG. 5 and the radial position R (1, TO, o) of the outermost circumferential track of the test area in the vicinity of the outer circumference of the second information-recording area respectively, R5′ and R6′ represent the distances from the center of the first information section at the radial position R (0, D, i) of the innermost circumferential track on which information is recorded in the first information-recording area and the radial position R (0, D, o) of the outermost circumferential track on which information is recorded in the first information-recording area respectively, r represents the radius of the light beam on the first information section when the light beam is collected on the second information section, and RRₚ₋ₚ represents the specification value of the eccentricity. When the test areas are provided at both of the portions in the vicinity of the inner circumference and the outer circumference of the second information-recording area of the second information section, the radial positions of the physical formats of the respective information sections may be designed so that the expressions (3)′ and (4)′ hold.

When the optical disk of the single-sided two-layered type is actually manufactured, the optical disk is manufactured so that the eccentricity amount is necessarily included in the specification value. Therefore, when the positional relationship of the physical format between the first and second information sections is designed beforehand so that the expression (3)′ and/or the expression (4)′ is satisfied, the relationship of the radial positions of the expression (3)′ and/or the expression (4)′ necessarily holds between the physical format of the first information section and the physical format of the second information section.

In the optical recording medium of the present invention, a track pitch of the first information section may have a size which is not less than that of a track pitch of the second information section. Further, in the optical recording medium of the present invention, a recording capacity of the first information section may be same as a recording capacity of the second information section.

When the positional relationship between the physical format of the first information section and the physical format of the second information section is, for example, the positional relationship as explained in FIG. 5, the area of the second information section (information-recording/reproducing area 65 in FIG. 5), in which the user information can be recorded, is narrower than the area of the first information section (information-recording/reproducing area 55 in FIG. 5) in which the user information can be recorded. Therefore, when the track pitch of the second information section is narrower than the track pitch of the first information section, it is possible to obtain the same recording capacity for the first information section and the second information section.

An explanation will be specifically made about a designing method to obtain the same recording capacity for the first information section and the second information section, as exemplified by an optical disk adapted to the blue laser by way of example. It is assumed that the thickness D of the spacer layer is 25 μm, the refractive index ns of the spacer layer is 1.5, and NA of the lens is 0.65. On this assumption, the radius r of the light beam on the first information section, which is obtained when the laser beam is collected on the second information section, is about 13.3 μm according to the numerical expression (numerical expression 1). Considering the eccentricity brought about when the first information section and the second information section are stuck to one another, it is assumed that the specification value RRₚ₋ₚ of the eccentricity is 50 μm. On this assumption, in the case of this example, the optical disk may be manufactured so that both of the radii of the inner and outer circumferences of the second information-recording area (area formed with the groove) of the second information section are narrower than the first information-recording area of the first information section by not less than 63.3 μm. It is assumed that the first information-recording area of the first information section ranges from a radius of 23.8 mm to a radius of 58.0 mm, and the track pitch of the first information section is 0.40 μm. On this assumption, when the track pitch of the second information section is 0.398 μm, i.e., a track pitch which is narrower than the track pitch of the first information section by about 0.4%, then it is possible to obtain an equal number of tracks for the first information section and the second information section, and it is possible to obtain an identical capacity.

In the optical recording medium of the present invention, the first information section may have a first transition area which is disposed between the first preformat area and the first information-recording area. In the optical recording medium of the present invention, an area on the first substrate, which corresponds to the first transition area, may be a mirror surface.

In the optical recording medium of the present invention, the second information section may further include a second preformat area, and a second transition area which is provided between the second preformat area and the second information-recording area, and emboss pits may be provided in an area on the second substrate corresponding to the second preformat area.

In the optical recording medium of the present invention, the first transition area of the first information section and the test area of the second information section may be disposed in different areas.

In the optical recording medium of the present invention, each of the first and second recording layers may be formed of an organic dye material. In the optical recording medium of the present invention, each of the first and second recording layers may be formed of a phase-change material.

The optical recording medium of the present invention is formed so that the positional relationship between the physical format of the first information section and the physical format of the second information section satisfies the expression (1) and/or the expression (2) or the expression (3) and/or the expression (4). Accordingly, the light beam, which undergoes the extremely small fluctuation of the light amount, can be radiated onto the information-recording/reproducing area for recording the user information or the like and the test area of the second information section disposed on the side far from the incoming side of the light beam. Therefore, when information is recorded on the second information section disposed on the side far from the incoming side of the light beam, then the optimum recording power can be reliably determined, and the user information or the like can be stably recorded with the optimum recording power. Therefore, according to the optical recording medium of the single-sided two-layered type of the present invention, the process for recording and reproducing information can be performed stably and highly reliably on the information section (second information section) disposed on the side far from the incoming side of the light beam.

### BRIEF DESCRIPTION OF THE DRAWINGS

FIG. 1 shows a schematic sectional view illustrating an optical disk of the single-sided two-layered type according to a first embodiment of the present invention.

FIG. 2 shows a schematic arrangement of a physical format of an L0 layer of the optical disk according to the first embodiment of the present invention.

FIG. 3 shows a perspective view illustrating a structure of a concave/convex pattern formed on a surface of a substrate of the L0 layer of the optical disk according to the first embodiment of the present invention.

FIGS. 4A and 4B show the positional relationships between the physical formats of the L0 layer and the L1 layer according to the first embodiment of the present invention.

FIGS. 5A and 5B show the positional relationships between the physical formats of the L0 layer and the L1 layer according to a second embodiment of the present invention.

FIG. 6 illustrates the procedure for determining the radius of the light beam on the L0 layer when the light beam is collected on the L1 layer.

FIG. 7 shows a schematic arrangement of the physical format of an L0 layer of an optical disk manufactured in Example 1.

FIG. 8 shows a schematic sectional view illustrating a rewritable type optical disk manufactured in Example 3.

### DESCRIPTION OF THE PREFERRED EMBODIMENTS

An explanation will be specifically made below about embodiments of the optical recording medium of the present invention with reference to the drawings. However, the present invention is not limited thereto.

### First Embodiment

Film Structure

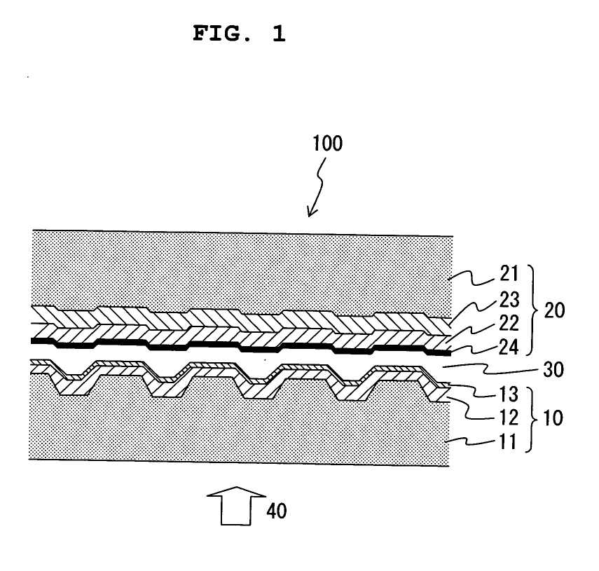

An optical disk having the single-sided two-layered structure is explained in the first embodiment. FIG. 1 shows a schematic sectional view illustrating the optical disk. As shown in FIG. 1, the optical disk 100 of this embodiment has such a structure that a first information section 10 (hereinafter referred to as “L0 layer” as well) and a second information section 20 (hereinafter referred to as “L1 layer” as well) are stuck to one another with an adhesive layer 30 (hereinafter referred to as “spacer layer” as well) intervening therebetween.

As shown in FIG. 1, the L0 layer 10 has a first recording layer 12 and a first reflective layer 13 which are stacked in this order on a first substrate 11. As shown in FIG. 1, the L1 layer 20 has a second reflective layer 23, a second recording layer 22, and an interface layer 24 which are stacked in this order on a second substrate 21. The L0 layer 10 and the L1 layer 20 are stuck to one another with the spacer layer 30 intervening therebetween so that the first reflective layer 13 of the L0 layer 10 is opposed to the interface layer 24 of the L1 layer 20. In this illustrative embodiment, as shown in FIG. 1, the light beam 40 comes from the side of the first substrate 11 of the L0 layer 10.

Each of the first substrate 11 and the second substrate 21 is a light-transmissive substrate. Emboss pits for recording, for example, the disk management information for each layer (L0 layer or L1 layer) and the guide groove (groove) for recording, for example, the user information are previously formed on the surface of each of the substrates. As for the material for the first substrate 11 and the second substrate 21, it is desirable to use a resin which has a refractive index within a range of 1.4 to 1.7, which has a large transmittance, and which is excellent in the impact resistance. Specifically, it is possible to use, for example, polycarbonate, amorphous polyolefin, and acrylic resin. However, the present invention is not limited thereto. Any arbitrary material may be used as the material for the substrate provided that the material has the properties as described above, As shown in FIG. 1, it is unnecessary that the light is transmitted through the second substrate 21, because the second substrate 21 is arranged on the opposite to the incoming side of the light beam. However, considering the fact that the mechanical properties should be satisfactorily maintained after adhering the L0 layer 10 and the L1 layer 20, it is preferable for the second substrate 21 to use the same material as that of the first substrate 11.

The first recording layer 12 and the second recording layer 22 are the layers to function such that the radiated light beam is absorbed to cause the heat generation, the melting, the evaporation, the sublimation, the deformation, the denaturation, the phase change, and/or the phase transformation in order to form recording pits in the recording layer itself or on the surface of the substrate. When the write-once type optical disk is manufactured, it is desirable to use an organic dye having a property to absorb the light as the material for forming the first recording layer 12 and the second recording layer 22. It is possible to use, for example, cyanine dye, polymethine dye, triarylmethane dye, pyrylium dye, phenanthrene dye, azo dye, tetrahydrocholine dye, triarylamine dye, squalirium dye, and croconic methine dye. However, the dye material, which is usable for the recording layer of the present invention, is not limited to the dye materials as described above. It is also allowable that the materials for forming the first recording layer 12 and the second recording layer 22 contain, for example, other dyes, additives, high molecular weight compounds (for example, thermoplastic resin such as nitrocellulose and thermoplastic elastomer).

When a dye material as described above or a material obtained by containing an arbitrary additive therein is used as the material for forming the first recording layer 12 and the second recording layer 22, the first recording layer 12 and the second recording layer 22 are formed, for example, by a method in which the dye material as described above or the material obtained by containing the arbitrary additive therein is dissolved in or solvated with a known organic solvent (for example, tetrafluoropropanol, ketone alcohol, acetylacetone, methycellosolve, toluene), and the first substrate 11 and the second reflective layer 23 are spin-coated therewith respectively. When the spin coat method is used as the means for forming the recording layer, the film thickness of the recording layer can be controlled by regulating the concentration and the viscosity of the dye solution and the drying speed of the solvent. When the first recording layer 12 and the second recording layer 22 are formed by the spin coat method, they may be formed while appropriately changing, for example, the dye material, the coating condition, and the solvent depending on the way of use.

On the other hand, when the optical disk of the write-once type or the rewritable type is manufactured, a phase-change material may be used as the material for forming the first recording layer 12 and the second recording layer 22. Those usable as the phase-change material include, for example, a material obtained by substituting a part of a Bi—Ge—Te-based material with Si, B, Pb, Sn or the like, a material obtained by adding a metal such as Ag, Al, Cr, and Mn to a Ge—Sn—Sb—Te-based material, and an Ag—In—Sb—Te-based recording material. However, the phase-change material, which is usable for the recording layer of the present invention, is not limited to the materials as described above. When the first and second recording layers are formed of the phase-change material as described above, it is preferable to form the first and second recording layers by means of the vapor deposition method or the sputtering method.

Each of the first reflective layer 13 and the second reflective layer 23 is composed of a metal film which is formed of, for example, gold, silver, aluminum, or an alloy containing such a metal element. The metal films are formed by the means including, for example, the sputtering method.

The interface layer 24 of the L1 layer 20 is an essential layer in order to chemically protect the second recording layer 22 from the adhesive and/or the solvent for the adhesive when the L0 layer 10 and the L1 layer 20 are stuck to one another. It is appropriate to use a variety of dielectric materials as the material for forming the interface layer 24. It is possible to use, for example, oxides such as SiO₂, Al₂O₃, TiO₂, and Ta₂O₅; nitrides such as SiN, AlN, and TiN; and sulfides such as ZnS. It is necessary that the interface layer 24 has such a property that the interface layer 24 has little optical absorbance, the interface layer 24 is chemically stable, and the interface layer 24 has a protecting effect.

It is desirable that the spacer layer 30 is formed of a resin which is excellent in the impact resistance. The spacer layer 30 is formed, for example, by applying an ultraviolet-curable resin by means of the spin coat method followed by being irradiated with the ultraviolet light to effect the curing. Alternatively, the spacer layer 30 may be formed of an elastic material such as urethane.

The film structure of the optical recording medium of the present invention is not limited to the structure shown in FIG. 1. A solvent-resistant layer and/or an enhance layer such as SiO₂ and ZnS—SiO₂ may be provided between the first substrate 11 and the first recording layer 12. Further, an oxidation-resistant layer and/or an enhance layer composed of, for example, SiO₂, ZnS—SiO₂, or Al₂O₃ may be provided between the recording layer and the reflective layer. Further, a protective layer may be formed on the reflective layer. In this arrangement, it is enough that the protective layer is a layer having a function capable of protecting the recording layer and the reflective layer. For example, the protective layer may be formed of an ultraviolet-curable resin or a silicone-based resin. If necessary, a printing layer or a printing-receiving layer may be provided on the second substrate 21.

Arrangement of Physical Format

Next, an explanation will be made about an arrangement of the physical format of the optical disk according to the first embodiment.

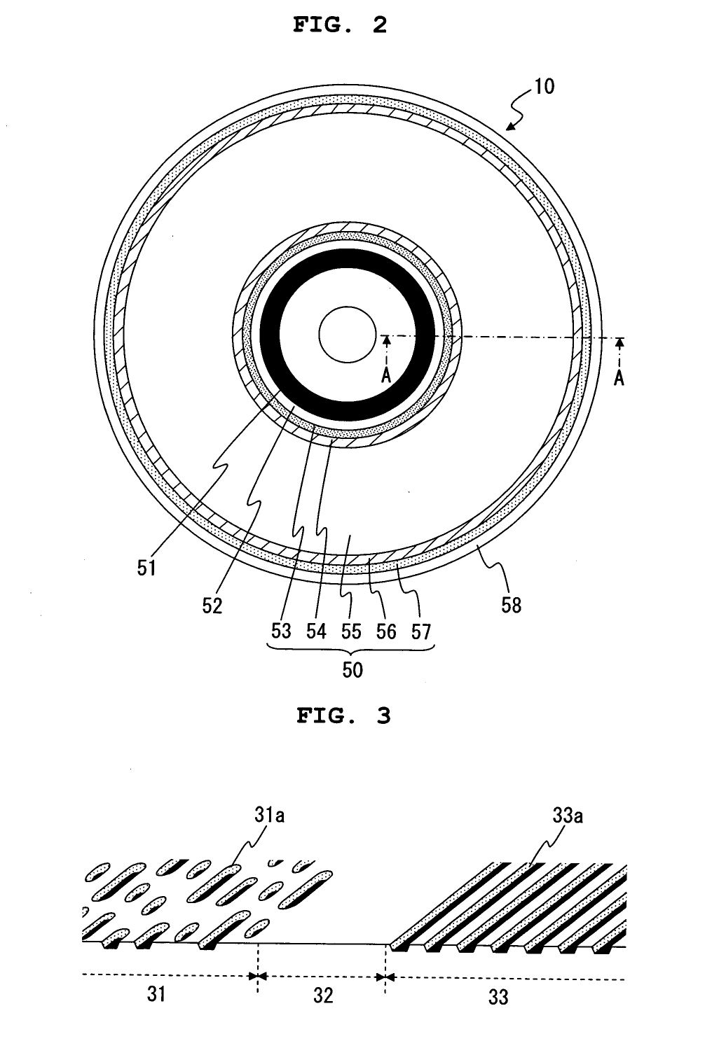

FIG. 2 shows an exemplary arrangement of the physical format of the information section (L0 layer) disposed on the side near to the light-incoming side of the optical disk of the first embodiment. As shown in FIG. 2, the L0 layer 10 has a preformat area 51 (hereinafter referred to as “ROM area” as well) and an information-recording area 50 as arranged from the inner circumferential side. The disk management information or the like is recorded beforehand, for example, in a form of emboss pits in an area on the first substrate 11 corresponding to the ROM area 51. The guide groove (groove) for the light beam is formed in an area on the first substrate 11 corresponding to the information-recording area 50. As shown in FIG. 2, the information-recording area 50 includes an information-recording/reproducing area 55 in which the write-once information such as the user information is recorded and reproduced, test areas 54, 56 which are provided on the inner circumferential side and the outer circumferential side of the information-recording/reproducing area 55 respectively in order to determine the condition for the recording in the information-recording/reproducing area 55, and buffer areas 53, 57 which are provided on the inner circumferential side of the test area 54 and the outer circumferential side of the test area 56 respectively. The buffer areas 53, 57 are provided in order to maintain the flatness for the film thickness of the recording layer ranging to the area for performing the recording when the recording layer is formed by effecting the spin coat in order to manufacture, for example, the optical recording medium of the dye coating type. As shown in FIG. 2, a mirror area 58 (specular or mirror surface section) is provided on the outer circumferential side of the buffer area 57 which is disposed on the outer circumferential side.

In the case of the optical disk of the first embodiment, as shown in FIG. 2, a transition area 52 is provided as a third area between the ROM area 51 and the information-recording area 50. An area on the first substrate 11, which corresponds to the transition area 52, is a mirror surface in this embodiment. The transition area 52 is the area provided between the different format constructions. The transition area 52 is the area which is provided in order that (1) any crosstalk is avoided between the reproduced signal of the ROM area 51 and the reproduced signal of the information-recording area 50, and (2) the film thickness of the recording layer is formed to be uniform to realize the stabilization by adjusting the disturbance of the coating liquid caused in the ROM area 51 when the recording layer of the optical recording medium of the dye coating type is formed by means of the spin coat on the substrate.

On the other hand, the physical format of the L1 layer 20 adjoining the L0 layer 10 with the spacer layer 30 intervening therebetween may be constructed such that the ROM area is not provided. However, in the case of the optical disk of this embodiment, the physical format of the L1 layer 20 is the same as that of the L0 layer 10 (arrangement shown in FIG. 2). However, the optical disk of this embodiment is formed such that the radial positions of the respective areas in the physical format of the L0 layer 10 are deviated from the radial positions of the respective areas in the physical format of the L1 layer 20 as described later on. The stack of the respective constitutive films shown in FIG. 1 is formed on the entire region including the ROM area, the information-recording area, and the transition area for both of the L0 layer 10 and the L1 layer 20.

FIG. 3 schematically shows an example of the concave/convex pattern formed on the first substrate corresponding to the ROM area, the transition area, and the information-recording area (area having the groove formed on the first substrate, including the information-recording/reproducing area, the test area, and the buffer area) in each of the information sections of the optical disk of the first embodiment. As shown in FIG. 3, pits 31a are formed in the ROM area 31. The management information or the like of each of the information sections is recorded by the pits 31a. The groove (guide groove) 33a is formed in a spiral form in the information-recording area 33 in order to guide the light beam when the user information or the like is recorded in the information-recording area 33. The information is recorded in the information-recording area 33 by recording marks. Prepits may be provided in the information-recording area 33 in order to add the additional information such as the address information. The additional information may be recorded by meandering the groove. The transition area 32, which is provided between the preformat area 31 and the information-recording area 33, is allowed to remain as the mirror surface section to which neither groove nor pit is applied or formed. Even when the constitutive films on the respective areas have the same stacked structure, the reflectance and the transmittance differ between the respective areas depending on, for example, the diffraction at the emboss pits and the groove and the change of the film thickness of the recording layer at the groove.

Positional Relationship between Physical Formats of L0 Layer and L1 Layer

The optical disk of the first embodiment is formed while deviating the radial positions of the respective areas in the physical format of the L0 layer from the radial positions of the respective areas in the physical format of the L1 layer so that the transmittance of the area of the L0 layer through which the light beam passes is constant when the light beam is radiated over the range of the information-recording/reproducing area and the test area of the L1 layer as the information section disposed on the side far from the light-incoming side. Specifically, the radial positions of the respective physical formats of the L0 layer and the L1 layer are adjusted so that the light beam does not pass through the ROM area, the transition area, and the mirror area of the L0 layer in which the transmittance is fluctuated when the light beam is radiated over the range of the information-recording/reproducing area and the test area of the L1 layer.

The positional relationship as described above is specifically represented by the numerical expressions as follows. It is assumed that R1, R2, R3, and R4 represent the distances from the center of the optical disk at the radial position of the innermost circumferential track in the test area on the inner circumferential side of the L1 layer, the radial position of the outermost circumferential track of the test area on the outer circumferential side of the L1 layer, the radial position of the innermost guide groove of the information-recording area of the L0 layer, and the radial position of the outermost guide groove of the information-recording area of the L0 layer respectively, and r represents the radius of the light beam on the L0 layer when the light beam is collected on the L1 layer. On this assumption, the radial positions of the respective physical formats of the L0 layer and the L1 layer are adjusted so that both of the following relationships hold:
R1≧R3+r (1)
R2≦R4−r (2)

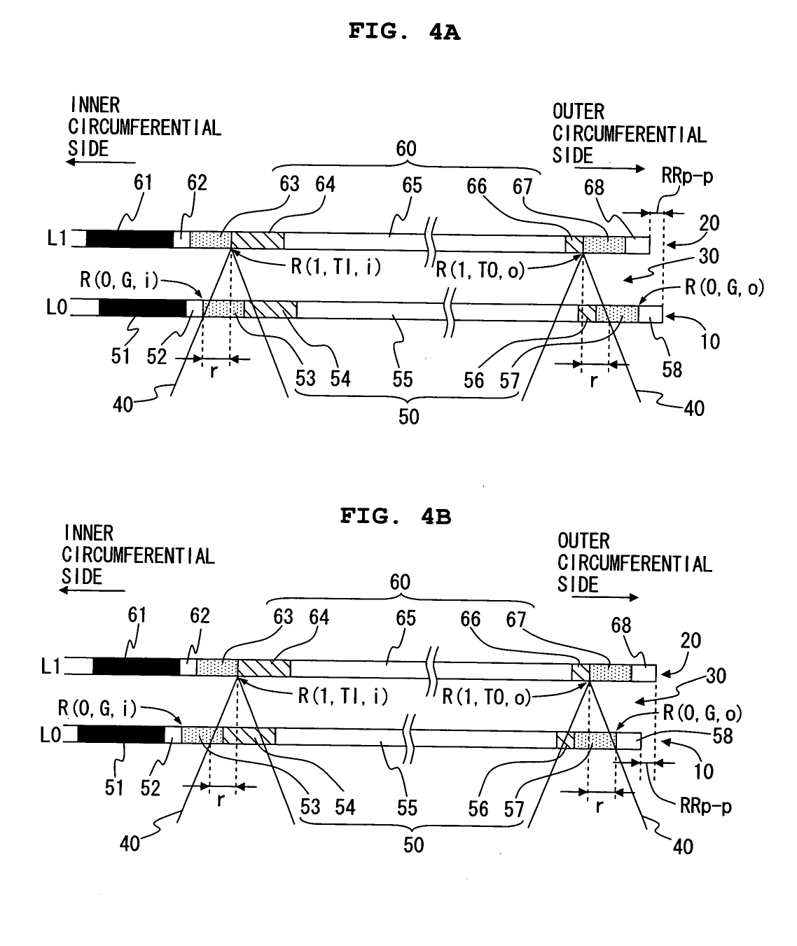

FIG. 4 shows an example of the positional relationship between the physical formats of the L0 layer and the L1 layer to satisfy the relationships of the expressions (1) and (2). It is preferable that the optical disk is designed by using the expressions (1)′ and (2)′ considering the eccentricity brought about when the L0 layer and the L1 layer are stuck to one another as described above, at the stage at which the positional relationships between the physical formats of the L0 layer and the L1 layer of the optical disk of the first embodiment are practically designed.

FIG. 4 shows sectional views (cross sections taken along a line A-A shown in FIG. 2) illustrating schematic arrangements in the radial direction of the respective physical formats of the L0 layer 10 and the L1 layer 20 adjoining to one another with the spacer layer 30 intervening therebetween. The outer circumferential side direction is the direction directed from the left side to the right side in the drawing. FIG. 4A shows the positional relationship between the physical formats of the L0 layer 10 and the L1 layer 20 when the lower limit condition of the expression (1) holds for the radial position R (1, TI, i) of the innermost circumferential track of the test area 64 disposed on the inner circumferential side of the L1 layer 20. That is, FIG. 4A shows the positional relationship between the physical formats of the L0 layer 10 and the L1 layer 20 when the relationship of R1=R3+r holds in relation to the distances R1, R3 from the center of the optical disk at the radial position R (1, TI, i) of the innermost circumferential track of the test area 64 disposed on the inner circumferential side of the L1 layer 20, and the radial position R (0, G, i) of the innermost guide groove of the information-recording area 50 of the L0 layer 10, and the radius r of the light beam on the L0 layer 10 when the light beam is collected on the L1 layer 20.

On the other hand, FIG. 4B shows the positional relationship between the physical formats of the L0 layer 10 and the L1 layer 20 when the upper limit condition of the expression (2) holds for the radial position R (1, TO, o) of the outermost circumferential track of the test area 66 disposed on the outer circumferential side of the L1 layer 20. That is, FIG. 4B shows the positional relationship between the physical formats of the L0 layer 10 and the L1 layer 20 when the relationship of R2=R4−r holds in relation to the distances R2, R4 from the center of the optical disk at the radial position R (1, TO, o) of the outermost circumferential track of the test area 66 disposed on the outer circumferential side of the L1 layer 20, and the radial position R (0, G, o) of the outermost guide groove of the information-recording area 50 of the L0 layer 10, and the radius r of the light beam on the L0 layer 10 when the light beam is collected on the L1 layer 20.

In the case of the optical disk in which the relationship of the radial positions as shown in FIG. 4A holds between the physical format of the L0 layer 10 and the physical format of the L1 layer 20, R1=R3+r (relationship of the expression (1)) holds for the radial position R (1, TI, i) of the innermost circumferential track of the test area 64 on the inner circumferential side of the L1 layer 20. Therefore, as shown in FIG. 4A, even when the light beam 40 is collected on the position R (1, TI, i) of the innermost circumferential track of the test area 64, the light beam 40 does not pass through the transition area 52 and the ROM area 51 of the L0 layer 10.

As clarified from FIG. 4A, the relationship of R2<R4−r (relationship of the expression (2)) holds for the radial position R (1, TO, o) of the outermost circumferential track of the test area 66 on the outer circumferential side of the L1 layer 20. Therefore, even when the light beam 40 is collected on the outermost circumferential position R (1, TO, o) of the test area 66 on the outer circumferential side of the L1 layer 20, the light beam 40 does not pass through the mirror area 58 on the outer circumferential side of the L0 layer 10.

On the other hand, in the case of the optical disk in which the relationship of the radial positions as shown in FIG. 4B holds between the physical format of the L0 layer 10 and the physical format of the L1 layer 20, R2=R4−r (relationship of the expression (2)) holds for the radial position R (1, TO, o) of the outermost circumferential track of the test area 66 on the outer circumferential side of the L1 layer 20. Therefore, as shown in FIG. 4B, even when the light beam 40 is collected on the position R (1, TO, o) of the outermost circumferential track of the test area 66, the light beam 40 does not pass through the mirror area 58 of the L0 layer 10.

As clarified from FIG. 4B, the relationship of R1>R3+ r (relationship of the expression (1)) holds for the radial position R (1, TI, i) of the innermost circumferential track of the test area 64 on the inner circumferential side of the L1 layer 20. Therefore, even when the light beam 40 is collected on the innermost circumferential position R (1, TI, i) of the test area 64 on the inner circumferential side of the L1 layer 20, the light beam 40 does not pass through the transition area 52 and the ROM area 51 of the L0 layer 10.

That is, in the case of the optical disk in which the relationships (relationships of the expressions (1) and (2)) as shown in FIGS. 4A and 4B hold between the physical format of the L0 layer 10 and the physical format of the L1 layer 20, the light beam, which is collected over the entire region of the test areas 64, 66 and the information-recording/reproducing area 65 of the L1 layer 20, does not pass through the ROM area 51, the transition area 52, and the mirror area 58 of the L0 layer 10 in which the transmittance is fluctuated, and the light beam passes through only the area (information-recording area) 50 of the L0 layer in which the groove is formed. The information-recording area 50 of the L0 layer is the area in which the groove is formed over the entire region (area in which the uniform concave/convex pattern is formed). Accordingly, the light beam 40, which passes through the information-recording area 50 of the L0 layer 10, has the transmittance which is approximately constant over the entire region of the information-recording area 50. Therefore, in the case of the optical disk in which the relationships of the radial positions as shown in FIGS. 4A and 4B hold between the physical format of the L0 layer 10 and the physical format of the L1 layer 20, the light beam 40, which is radiated onto the test areas 64, 66 and the information-recording/reproducing area 65 of the L1 layer 20, passes through only the information-recording area 50 of the L0 layer 10 in which the transmittance is approximately constant. Therefore, it is possible to suppress the variation or fluctuation of the light amount of the light beam 40 which arrives at the test areas 64, 66 and the information-recording/reproducing area 65 of the L1 layer 20.

As described above, in the case of the optical disk of the first embodiment in which the positional relationships (relationships of the expressions (1) and (2)) as shown in FIG. 4 hold between the physical format of the L0 layer 10 and the physical format of the L1 layer 20, the light beam 40, in which the light amount fluctuation is extremely small, is radiated onto the test areas 64, 66 disposed on the inner circumferential side and the outer circumferential side of the L1 layer 20. Therefore, it is possible to certainly determine the optimum recording power to be used during the recording of information. Further, the light beam, which arrives at the information-recording/reproducing area 65 of the L1 layer 20, undergoes the extremely small light amount fluctuation as well. Accordingly, the user information or the like can be stably recorded with the optimum recording power in the information-recording/reproducing area 65 of the L1 layer 20. Therefore, when the relationships of the radial positions between the physical format of the L0 layer 10 and the physical format of the L1 layer 20 are adjusted so that the relationships of the expressions (1) and (2) hold, information can be recorded and reproduced stably and highly reliably on the information section (L1 layer) disposed on the side far from the incoming side of the light beam 40.

The first embodiment has been explained as exemplified by the optical disk which has the test areas at both of the portions disposed in the vicinity of the inner circumference and the outer circumference of the second information-recording area of the L1 layer. However, the present invention is not limited thereto. When the test area is provided at only the portion disposed in the vicinity of the inner circumference of the second information-recording area of the L1 layer, it is appropriate that the relationship of the radial positions may be adjusted between the physical format of the L0 layer and the physical format of the L1 layer so that only the relationship of the expression (1) holds. When the test area is provided at only the portion disposed in the vicinity of the outer circumference of the second information-recording area of the L1 layer, it is appropriate that the relationship of the radial positions may be adjusted between the physical format of the L0 layer and the physical format of the L1 layer so that only the relationship of the expression (2) holds. In any case, it is clear that the effect is obtained in the same manner as in the first embodiment described above.

### Second Embodiment

The information section (L0 layer), which is disposed on the side near to the incoming side of the light beam, has the transmittance which is sometimes fluctuated depending on the recording state of the recording layer of the L0 layer as well, other than on the influence of the shape of the substrate of the L0 layer. For example, when the recording layer of the L0 layer is formed of any dye material, the transmittance is consequently changed before and after the recording of information on the recording layer in some cases. In particular, the fluctuation of the transmittance is more increased, because the recording is performed by changing the recording power from a lower power to a power larger than the optimum recording power in the test area for determining the recording power. The trial writing is not necessarily performed over the entire region of the test area. Therefore, the recorded area and the non-recorded area are present in a mixed manner in the test area in some cases. In such a situation, it is also feared that the transmittance of the light beam to pass through the test area is greatly changed.

In the second embodiment, an explanation will be made about the physical format of the optical disk of the single-sided two-layered type considering the case in which the light transmittance of the light beam to pass through the L0 layer is changed not only by the shape of the substrate in the L0 layer but also by the recording state of the test area. In the second embodiment, an explanation will be made about the physical format of the optical disk having the test areas provided at both of the portions disposed in the vicinity of the inner circumference and the outer circumference of the second information-recording area constructed of one layer in the same manner as in the first embodiment.

Arrangement of Physical Format

In order to solve the problem as described above, it is appropriate that the positional relationship is adjusted between the physical format of the L0 layer and the physical format of the L1 layer so that the light beam does not pass through the test area of the L0 layer when the light beam is radiated onto the test area of the information section (L1 layer) disposed on the side far from the incoming side of the light beam to perform the trial writing and when the light beam is radiated onto the information-recording/reproducing area of the L1 layer to record and reproduce the user information or the like.

The arrangement as described above is specifically represented by numerical expressions as follows. It is assumed that R1, R2, R5, and R6 represent the distances from the center of the optical disk at the radial position of the innermost circumferential track in the test area on the inner circumferential side of the L1 layer, the radial position of the outermost circumferential track of the test area on the outer circumferential side of the L1 layer, the radial position of the innermost circumferential track on which information is recorded in the information-recording area of the L0 layer, and the radial position of the outermost circumferential track on which information is recorded in the information-recording area of the L0 layer respectively, and r represents the radius of the light beam on the L0 layer when the light beam is collected on the L1 layer. On this assumption, the radial positions of the respective physical formats of the L0 layer and the L1 layer are adjusted so that both of the following relationships hold:
R1≧R5+r (3)
R2≦R6−r (4)
In the second embodiment, the film structure is the same as the optical disk of the single-sided two-layered type explained in the first embodiment (see FIG. 1), and the arrangement of the physical format is also the same (see FIG. 2), except that the positional relationship is changed between the physical format of the L0 layer and the physical format of the L1 layer.

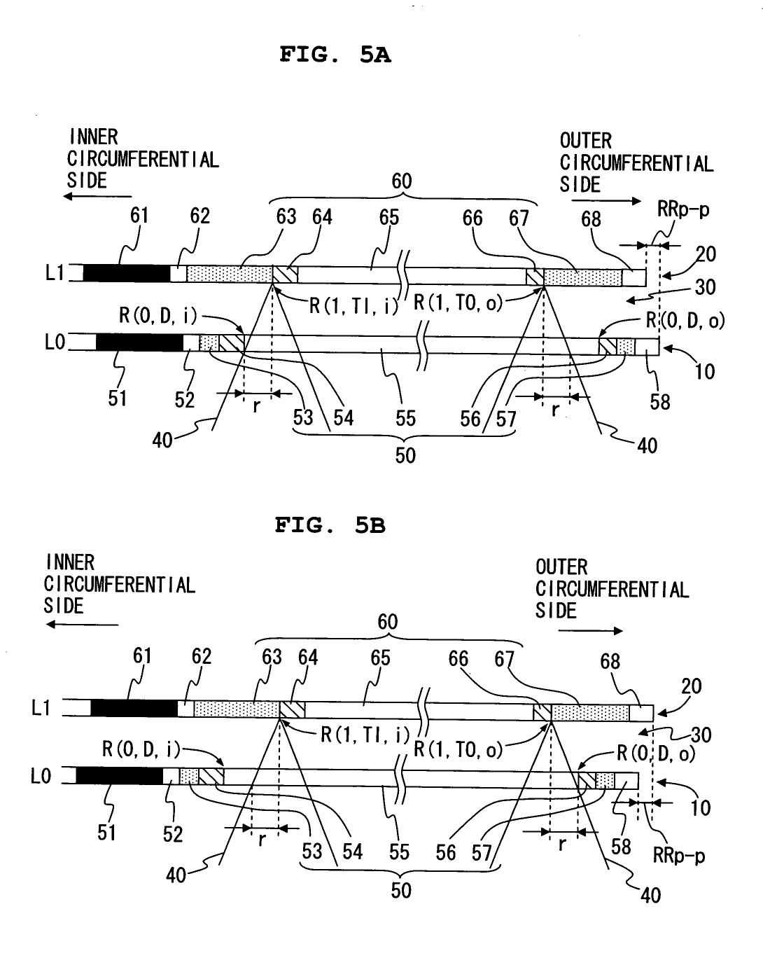

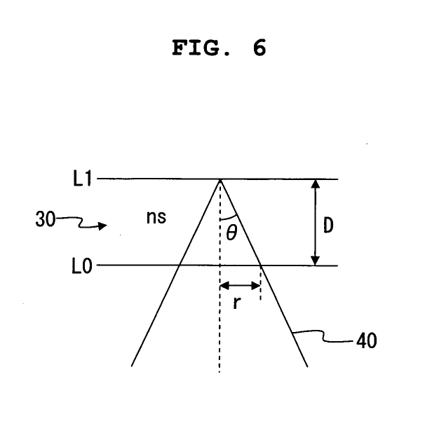

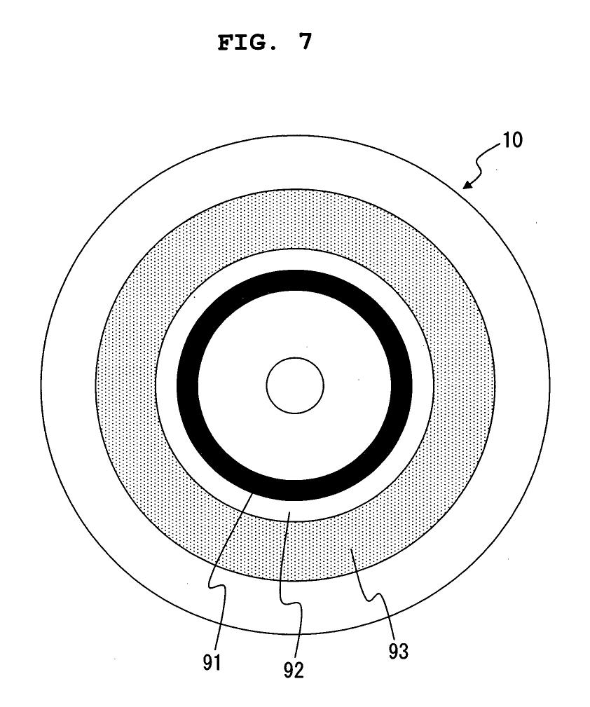

FIG. 5 shows an example of the positional relationship between the physical formats of the L0 layer and the L1 layer to satisfy the relationships of the expressions (3) and (4). It is preferable that the optical disk is designed by using the expressions (3)′ and (4)′ considering the eccentricity brought about when the L0 layer and the L1 layer are stuck to one another at the stage at which the positional relationships between the physical formats of the L0 layer and the L1 layer of the optical disk of the second embodiment are practically designed, in the same manner as in the first embodiment.

FIG. 5 shows sectional views (cross sections taken along a line A-A shown in FIG. 2) illustrating schematic arrangements in the radial direction of the respective physical formats of the L0 layer 10 and the L1 layer 20 adjoining to one another with the spacer layer 30 intervening therebetween. The outer circumferential side direction is the direction directed from the left side to the right side in the drawing. FIG. 5A shows the positional relationship between the physical formats of the L0 layer 10 and the L1 layer 20 when the lower limit condition of the expression (3) holds for the radial position R (1, TI, i) of the innermost circumferential track of the test area 64 disposed on the inner circumferential side of the L1 layer 20. That is, FIG. 5A shows the positional relationship between the physical formats of the L0 layer 10 and the L1 layer 20 when the relationship of R1=R5+r holds in relation to the distances R1, R5 from the center of the optical disk at the radial position R (1, TI, i) of the innermost circumferential track of the test area 64 disposed on the inner circumferential side of the L1 layer 20, and the radial position R (0, D, i) of the innermost circumferential track on which information (write-once information such as the user information) is recorded in the information-recording area 50 of the L0 layer (innermost circumferential track position of the information-recording/reproducing area 55 of the L0 layer 10 in FIG. 5), and the radius r of the light beam 40 on the L0 layer 10 when the light beam 40 is collected on the L1 layer 20.

On the other hand, FIG. 5B shows the positional relationship between the physical formats of the L0 layer 10 and the L1 layer 20 when the upper limit condition of the expression (4) holds for the radial position R (1, TO, o) of the outermost circumferential track of the test area 66 disposed on the outer circumferential side of the L1 layer 20. That is, FIG. 5B shows the positional relationship between the physical formats of the L0 layer 10 and the L1 layer 20 when the relationship of R2=R6−r holds in relation to the distances R2, R6 from the center of the optical disk at the radial position R (1, TO, o) of the outermost circumferential track of the test area 66 disposed on the outer circumferential side of the L1 layer 20, and the radial position R (0, D, o) of the outermost circumferential track on which information is recorded in the information-recording area 50 of the L0 layer 10 (outermost circumferential track position of the information-recording/reproducing area 55 of the L0 layer 10 shown in FIG. 5), and the radius r of the light beam on the L0 layer 10 when the light beam is collected on the L1 layer 20.

In the case of the optical disk in which the relationship of the radial positions as shown in FIG. 5A holds between the physical format of the L0 layer 10 and the physical format of the L1 layer 20, R1=R5+r (relationship of the expression (3)) holds for the radial position R (1, TI, i) of the innermost circumferential track of the test area 64 on the inner circumferential side of the L1 layer 20. Therefore, as shown in FIG. 5A, even when the light beam 40 is collected on the position R (1, TI, i) of the innermost circumferential track of the test area 64, the light beam 40 does not pass through test area 54, the transition area 52, and the ROM area 51 of the L0 layer 10.

As clarified from FIG. 5A, the relationship of R2≦R6−r (relationship of the expression (4)) holds for the radial position R (1, TO, o) of the outermost circumferential track of the test area 66 on the outer circumferential side of the L1 layer 20. Therefore, even when the light beam 40 is collected on the outermost circumferential position R (1, TO, o) of the test area 66 on the outer circumferential side of the L1 layer 20, the light beam 40 does not pass through test area 56 and the mirror area 58 on the outer circumferential side of the L0 layer 10.

On the other hand, in the case of the optical disk in which the relationship of the radial positions as shown in FIG. 5B holds between the physical format of the L0 layer 10 and the physical format of the L1 layer 20, R2=R6−r (relationship of the expression (4)) holds for the radial position R (1, TO, o) of the outermost circumferential track of the test area 66 on the outer circumferential side of the L1 layer 20. Therefore, as shown in FIG. 5B, even when the light beam 40 is collected on the position R (1, TO, o) of the outermost circumferential track of the test area 66, the light beam 40 does not pass through the test area 56 and the mirror area 58 on the outer circumferential side of the L0 layer 10.

As clarified from FIG. 5B, the relationship of R1>R5+r (relationship of the expression (3)) holds for the radial position R (1, TI, i) of the innermost circumferential track of the test area 64 on the inner circumferential side of the L1 layer 20. Therefore, even when the light beam 40 is collected on the innermost circumferential position R (1, TI, i) of the test area 64 on the inner circumferential side of the L1 layer 20, the light beam 40 does not pass through the test area 54, the transition area 52, and the ROM area 51 on the inner circumferential side of the L0 layer 10.

That is, in the case of the optical disk in which the positional relationships (relationships of the expressions (3) and (4)) as shown in FIGS. 5A and 5B hold between the physical format of the L0 layer 10 and the physical format of the L1 layer 20, the light beam, which is collected over the entire region of the test areas 64, 66 and the information-recording/reproducing area 65 of the L1 layer 20, does not pass through not only the ROM area 51, the transition area 52, and the mirror area 58 of the L0 layer 10 in which the transmittance is fluctuated, but also the test areas 54, 56 in which the transmittance is possibly fluctuated depending on the recording state, and the light beam passes through only the information-recording/reproducing area 55 of the L0 layer 10. The groove is formed over the entire region of the information-recording/reproducing area 55 of the L0 layer 10, and information is recorded at a predetermined recording power. Usually, information is recorded from the L0 layer 10. Therefore, a state is given at the point of time at which information is recorded in the L1 layer 20, in which the user information or the like is uniformly recorded in the entire region of the information-recording/reproducing area 55 of the L0 layer 10. Accordingly, the light beam, which passes through the information-recording/reproducing area 55 of the L0 layer 10, has the transmittance which is approximately uniform. Therefore, in the case of the optical disk of this embodiment in which the relationships of the radial positions as shown in FIGS. 5A and 5B hold between the physical format of the L0 layer 10 and the physical format of the L1 layer 20, the light beam 40, which is radiated onto the test areas 64, 66 and the information-recording/reproducing area 65 of the L1 layer 20, passes through only the information-recording/reproducing area 55 of the L0 layer 10 in which the transmittance is approximately constant, even when the light transmittance is fluctuated depending not only on the shape of the first substrate of the L0 layer 10 but also on the recording states of the test areas 54, 56. Therefore, it is possible to suppress the variation or fluctuation of the light amount of the light beam 40 to arrive at the test areas 64, 66 and the information-recording/reproducing area 65 of the L1 layer 20.

As described above, in the case of the optical disk of the second embodiment in which the positional relationships as shown in FIG. 5 (relationships of the expressions (3) and (4)) hold between the physical format of the L0 layer 10 and the physical format of the L1 layer 20, the light beam 40, in which the light amount fluctuation is extremely small, is radiated onto the test areas 64, 66 on the inner circumferential side and the outer circumferential side of the L1 layer 20, even when the light transmittance is varied depending not only on the shape of the first substrate of the L0 layer 10 but also on the recording states of the test areas 54, 56. Therefore, it is possible to certainly determine the optimum recording power to be used during the recording of information. Further, the light beam, which arrives at the information-recording/reproducing area 65 of the L1 layer 20, undergoes the extremely small light amount fluctuation as well. Accordingly, the user information or the like can be stably recorded with the optimum recording power in the information-recording/reproducing area 65 of the L1 layer 20. Therefore, the relationships of the radial positions between the physical format of the L0 layer 10 and the physical format of the L1 layer 20 are adjusted so that the relationships of the expressions (3) and (4) hold, as in the optical disk of the single-sided two-layered type of this embodiment, and thus information can be recorded and reproduced stably and highly reliably on the information section (L1 layer) disposed on the side far from the incoming side of the light beam 40.

The second embodiment has been explained in relation to the optical disk which has the test areas at both of the portions disposed in the vicinity of the inner circumference and the outer circumference of the second information-recording area of the L1 layer as described above. However, the present invention is not limited thereto. When the test area is provided at only the portion disposed in the vicinity of the inner circumference of the second information-recording area of the L1 layer, it is appropriate that the relationship of the radial positions may be adjusted between the physical format of the L0 layer and the physical format of the L1 layer so that only the relationship of the expression (3) holds. When the test area is provided at only the portion disposed in the vicinity of the outer circumference of the second information-recording area of the L1 layer, it is appropriate that the relationship of the radial positions may be adjusted between the physical format of the L0 layer and the physical format of the L1 layer so that only the relationship of the expression (4) holds. In any case, it is clear that the effect is obtained in the same manner as in the second embodiment described above.

The optical disks of the first and second embodiments described above are illustrative of the case in which the area on the substrate corresponding to the transition area is the mirror surface. However, the present invention is not limited thereto. The present invention is also applicable in the same manner as described above, and the same effect is obtained in relation to optical disks having those other than the mirror surface, in which the area on the substrate corresponding to the transition area is formed of a concave/convex pattern composed of a groove, pits, or a combination thereof, and the light transmittance of the transition area is different from those of the other areas (preformat area and information-recording area).

### EXAMPLE 1

In Example 1, a write-once type optical disk was manufactured, which was adapted to the red laser, which was of the single-sided two-layered type, and which had a recording layer formed of a dye material. In the case of the optical disk of Example 1, the physical formats of the respective information sections were adjusted so that the positional relationships of the physical formats between the L0 layer and the L1 layer satisfied the expressions (1) and (2). The optical disk of Example 1 had the same film structure as that shown in FIG. 1.

When the optical recording medium of the single-sided two-layered type as shown in FIG. 1 is manufactured, several methods are principally available, but they are roughly classified into those of the two types. The first method is a method in which the two recording layers of the L0 layer and the L1 layer are successively stacked on one substrate. The second method is a method in which the recording layers of the L0 layer and the L1 layer are stacked on distinct substrates respectively, and then the both are stuck to one another. When the optical recording medium is manufactured by means of the second method, it is necessary that the stacking sequence or order of the respective stacked films on the substrate in the L1 layer should be reverse to the stacking sequence or order of those in the L0 layer. Even when any one of the manufacturing methods described above is used for the optical disk of the present invention, it is possible to exhibit the effect thereof. However, in Example 1, the latter method was adopted.

Production of Test Disk for Evaluating Transmittance and Measurement of Transmittance

At first, an explanation will be made about the relationship between the transmittance and the physical format of the L0 layer in the optical disk of the single-sided two-layered type which is adapted to the red laser and which is based on the use of the dye material for the recording layer, before explaining details of the optical disk of Example 1. In order to investigate the relationship between the transmittance and the physical format of the L0 layer, a test disk of the single-sided two-layered type having the same or equivalent physical format as that of DVD-R (hereinafter referred to as “transmittance-evaluating test disk” as well) was manufactured.

As shown in FIG. 7, the physical format of the L0 layer of the transmittance-evaluating test disk was composed of, from the inner circumferential side, a ROM area 91, a transition area 92, and an information-recording area 93 (including a buffer area, a test area, and an information-recording/reproducing area). Emboss pits were formed in an area on a substrate of the L0 layer corresponding to the ROM area 91, and a groove was formed in an area on the substrate corresponding to the information-recording area 93. An area on the substrate of the L0 layer corresponding to the transition area 92 was a mirror surface. Specifically, a pit array having a track pitch of 0.74 μm and a half value width of 0.32 μm was formed in the area on the substrate of the L0 layer corresponding to the ROM area 91 to record DVD-ROM data. A groove having a track pitch of 0.74 μm, a half value width of 0.32 μm, and a depth of 170 nm was formed in the area on the substrate corresponding to the information-recording area 93. The transition area 92 had a width in the radial direction of about 100 μm. On the other hand, a groove (guide groove) having a track pitch of 0.74 μm, a half value width of 0.37 μm, and a depth of 30 nm was formed from the innermost circumference to the outermost circumference of the transmittance-evaluating test disk on the surface of the substrate of the L1 layer of the disk. The film structure of the transmittance-evaluating test disk was constructed as shown in FIG. 1.

Another test disk (hereinafter referred to as “reference test disk” as well) was also manufactured as a test disk to serve as the reference for the evaluation of the transmittance, in which a dummy substrate (substrate formed with no convex/concave pattern on the surface) was stuck to the L1 layer in place of the L0 layer.

Next, an explanation will be made about a method for manufacturing the transmittance-evaluating test disk with reference to FIG. 1. The method for manufacturing the optical disk of the single-sided two-layered type of Example 1 is the same as the method for manufacturing the transmittance-evaluating test disk explained below.

At first, the L0 layer 10 was manufactured as follows. A stamper was manufactured, which was formed with a concave/convex pattern corresponding to the groove (guide groove) pattern and the pit array to be formed on the first substrate 11. Subsequently, the manufactured stamper was installed to an existing injection molding machine, and a polycarbonate resin of the grade for the optical information-recording medium was subjected to the injection molding to obtain the first substrate 11 of the L0 layer 10 of the test disk. In this case, the substrate made of polycarbonate having a diameter of 120 mm and a thickness of 0.6 mm was manufactured.

Subsequently, the surface of the first substrate 11, which was formed with the concave/convex pattern, was coated by the spin coat method with a tetrafluoropropanol solution having a concentration of 1.3% by weight of an azo-based dye represented by the following chemical formula (chemical formula 1). When the dye solution was subjected to the coating, the dye solution was filtrated through a filter to remove impurities. When the spin coat was performed, 0.5 g of the dye solution was supplied with a dispenser onto the first substrate 11 rotating at a number of revolutions of 100 rpm. After that, the first substrate 11 was rotated over a range from 1,000 rpm to 3,000 rpm, and the first substrate 11 was finally rotated for 2 seconds at 5,000 rpm. In this procedure, the solution was coated so that the thickness was 130 nm at the groove portion. Subsequently, the first substrate 11, on which the dye material had been coated, was dried at 70° C. for 1 hour, followed by being cooled at room temperature for 1 hour. Thus, the first recording layer 12 was formed on the first substrate 11.

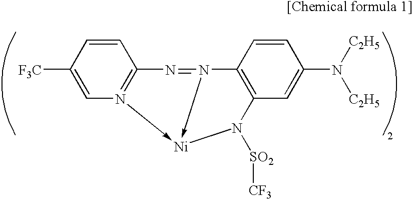

Further, an Ag film having a thickness of 160 nm was formed as the first reflective layer 13 on the first recording layer 12 by using the sputtering method. Thus, the L0 layer 10 was manufactured.

Subsequently, the L1 layer 20 was manufactured as follows. At first, the second substrate 21 of the L1 layer 20 was manufactured in the same manner as the first substrate 11 of the L0 layer 10. The second substrate 21 of the L1 layer 20 was a substrate made of polycarbonate having a diameter of 120 mm and a thickness of 0.6 mm. A groove having a track pitch of 0.74 μm, a half value width of 0.37 μm, and a depth of 30 nm was formed from the inner circumferential side to the outer circumferential side on the surface of the substrate as described above. As for the L1 layer 20, the laser beam is radiated from the side of the second substrate 21 on which the groove pattern is formed. Therefore, considering this fact, the groove pattern was formed in a spiral form in a direction opposite to that of the L0 layer 10. In the case of the L1 layer 20, the respective constitutive layers were formed in an order opposite to that of the L0 layer 10, on the groove pattern-formed surface of the second substrate 21.

At first, an Ag film having a thickness of 160 nm was formed as the second reflective layer 23 on the second substrate 21 by using the sputtering method. Subsequently, the surface of the second reflective layer 23 was coated by the spin coat method with a tetrafluoropropanol solution having a concentration of 1.3% by weight of the azo-based dye represented by the chemical formula described above (chemical formula 1) to form the second recording layer 22. In this procedure, the solution was applied under the same condition as that used for the formation of the first recording layer 12 of the L0 layer 10 as described above to form the second recording layer 22. The film thickness was 200 nm. Subsequently, the second substrate 21, on which the dye material had been coated as described above, was dried at 70° C. for 1 hour, followed by being cooled at room temperature for 1 hour. Subsequently, a ZnS—SiO₂ film having a film thickness of 10 nm was formed as the interface layer 24 on the second recording layer 22 by means of the sputtering method. Thus, the L1 layer 20 was formed.

Subsequently, the L0 layer 10 and the L1 layer 20, which had been manufactured as described above, were stuck to one another as follows. At first, the surface of the first reflective layer 13 of the L0 layer 10 was coated by the spin coat method with a UV resin material as the spacer layer 30. Further, the L1 layer 20 was placed thereon. In this procedure, the L1 layer 20 was placed on the spacer layer 30 so that the first reflective layer 13 of the L0 layer 10 was opposed to the interface layer 24 of the L1 layer 20 with the spacer layer 30 intervening therebetween. Subsequently, the UV radiation was applied from the side of the first substrate 11 of the L0 layer 10 in this state. Accordingly, the UV resin material was cured to stick the L0 layer 10 and the L1 layer 20 to one another. It is preferable that the thickness of the spacer layer 30 is 50 to 55 μm. In Example 1, the thickness was 55 μm. The transmittance-evaluating test disk was manufactured as described above. The reference test disk was manufactured in accordance with the same method as that described above except that the dummy substrate was stuck to the L1 layer in place of the L0 layer.

The transmittance of the L0 layer was measured for the transmittance-evaluating test disk and the reference test disk prepared in accordance with the manufacturing method as described above. The transmittance of the L0 layer at the groove portion (information-recording area) was measured for the non-recorded state and the state after the recording. In this procedure, the following recording condition was adopted. That is, the linear velocity was a linear velocity corresponding to ×2 speed of DVD, and the recording power was 12 mW. The laser beam used for the measurement had a wavelength of 650 nm. The focusing lens had a numerical aperture of NA=0.6. The transmittance was measured by using a parallel light beam having a wavelength of 650 nm. Results of the transmittance evaluation for the L0 layer are shown in Table 1. The transmittance in the column of “absent” in Table 1 is the transmittance of the reference test disk.

TABLE 1

| | | Mirror | | Groove | Groove |
|---|---|---|---|---|---|
| | | surface | ROM | (not | (after |
| L0 layer | Absent | section | section | recorded) | recording) |
| Transmittance | 1.0 | 0.76 | 0.70 | 0.65 | 0.63 |

Further, the optimum value of the recording power for the L1 layer was investigated when the laser beam was radiated onto the L1 layer through the respective areas of the L0 layer. In this procedure, the strategy of the recording pulse was identical, and the recording power, with which the asymmetry was absent, was regarded as the optimum recording power. Obtained results are shown in Table 2. The optimum recording power in the column of “absent” in Table 2 is the optimum recording power of the reference test disk.

TABLE 2

| | | Mirror | | Groove | Groove |
|---|---|---|---|---|---|
| | | surface | ROM | (not | (after |
| L0 layer | Absent | section | section | recorded) | recording) |
| Optimum | 10.8 | 14.2 | 15.4 | 16.6 | 17.1 |
| recording | | | | | |
| power (mW) | | | | | |

As clarified from the results shown in Tables 1 and 2, it has been revealed that the transmittance of the L0 layer differs and the optimum recording power for the L1 layer changes as well depending on the shape of the first substrate of the L0 layer through which the light beam passes. Further, as clarified from Table 1, it has been revealed that the transmittance of the L0 layer is varied to some extent depending on the recording state of the first recording layer as well, because the dye material is used for the recording layer in Example 1. Therefore, it has been clarified that it is important to maintain the constant transmittance of the area of the L0 layer through which the light beam passes, for example, when information is recorded and reproduced by radiating the light beam onto the information-recording/reproducing area and the test area of the L1 layer.

Arrangement of Optical Disk of Example 1

In Example 1, the optical disk of the single-sided two-layered type was manufactured, in which both of the L0 layer and the L1 layer were formed with the physical format as shown in FIG. 2, and the positional relationships of the respective areas in the physical formats between the L0 layer and the L1 layer was the relationships as shown in Table 3. Table 3 also shows the start radial position and the end radial position of each of the areas for constructing the physical formats of the L0 layer and the L1 layer. The numerical values shown in Table 3 are the values at the stage for designing the optical disk. The numerical values shown in the columns of the L0 layer are the distances from the center of the L0 layer, and the numerical values shown in the columns of the L1 layer are the distances from the center of the L1 layer.

TABLE 3

| | L0 layer | | L1 layer | |
|---|---|---|---|---|
| | Start (mm) | End (mm) | Start (mm) | End (mm) |
| ROM area | 23.300 | 23.779 | 23.300 | 23.779 |
| Transition (mirror | 23.780 | 23.799 | 23.780 | 23.799 |
| surface) area | | | | |
| Buffer area | 23.800 | 23.809 | 23.800 | 23.909 |
| Test area | 23.810 | 23.999 | 23.910 | 24.099 |
| Information- | 24.000 | 57.921 | 24.100 | 57.821 |
| recording/ | | | | |
| reproducing area | | | | |
| Test area | 57.922 | 58.020 | 57.822 | 57.920 |
| Buffer area | 58.021 | 58.499 | 57.921 | 58.499 |
| Mirror surface area | 58.500 | | 58.500 | |

In the optical disk of Example 1, the track pitch of the L1 layer was narrower than the track pitch of the L0 layer so that the number of tracks of the L0 layer was the same as the number of tracks of the L1 layer, i.e., the recording capacity of the L0 layer was the same as the recording capacity of the L1 layer. Specifically, the track pitch of the L0 was 0.74 μm, and the track pitch of the L1 layer was 0.736 μm. The groove, which was formed in the area on the first substrate corresponding to the information-recording area of the L0 layer of the optical disk of Example 1, had the dimension which was the same as the dimension (track pitch: 0.74 μm, half value width: 0.32 μm, depth: 170 nm) of the transmittance-evaluating test disk. The groove, which was formed in the area on the second substrate corresponding to the information-recording area of the L1 layer, had the dimension in which the track pitch was 0.736 μm, the half value width was 0.37 μm, and the depth was 30 nm.

The optical disk of Example 1 had the same structure as that of the transmittance-evaluating test disk described above except that the physical format arrangement of the L0 layer was the same as that of the L1 layer, the radial positions of the respective areas in the physical formats of the L0 layer and the L1 layer were adjusted as shown in Table 3, and the track pitch was changed for the L1 layer and the L0 layer. The optical disk of Example 1 was manufactured in accordance with the same method as that for the transmittance-evaluating test disk described above.

As clarified by the results of the measurement of the transmittance described above (Table 1), the transmittance of the L0 layer is greatly fluctuated depending on the shape of the first substrate of the L0 layer through which the light beam passes. Therefore, in the case of the optical disk of Example 1, the positional relationships of the respective areas in the physical formats of the L0 layer and the L1 layer were adjusted so that the light beam, which was collected over the entire region of the test area and the information-recording/reproducing area of the L1 layer, did not pass through the ROM area, the transition area, and the mirror area of the L0 layer in which the transmittance was fluctuated, and the light beam passed through only the information-recording area (area formed with the groove) of the L0 layer in which the transmittance was scarcely fluctuated.

In the case of the optical disk of Example 1, as clarified from Table 3, the following values are obtained at the designing stage. That is, the distance from the center of the L1 layer at the radial position R (1, TI, i) of the innermost circumferential track of the test area on the inner circumferential side of the L1 layer is R1′=23.910 mm. The distance from the center of the L1 layer at the radial position R (1, TO, o) of the outermost circumferential track of the test area on the outer circumferential side of the L1 layer is R2′=57.920 mm. The distance from the center of the L0 layer at the radial position R (0, G, i) of the innermost circumferential guide groove of the information-recording area of the L0 layer is R3′=23.810 mm. The distance from the center of the L0 layer at the radial position R (0, G, o) of the outermost circumferential guide groove of the information-recording area of the L0 layer is R4′=58.020 mm. When the optical disk of Example 1 was subjected to the recording and reproduction, then the laser beam having a wavelength of 650 nm was used, and the lens having a numerical aperture NA=0.6 was used for the focusing lens. The spacer layer of the optical disk was formed of a material having a refractive index ns=1.5 at the wavelength 650 nm, and the thickness D thereof was 55 μm. Therefore, in the case of the optical disk of Example 1, the radius r of the laser beam on the L0 layer was about 20 μm when the laser beam was collected on the L1 layer. In Example 1, the specification value RPₚ₋ₚ of the eccentricity amount upon the stacking of the L0 layer and the L1 layer was 70 μm.

Therefore, in the case of the optical disk of Example 1, the relationships of the expressions (1)′ and (2)′ hold at the designing stage in relation to the distances R1′, R2′ from the center of the L1 layer at the radial position R (1, TI, i) of the innermost circumferential track of the test area on the inner circumferential side of the L1 layer and the radial position R (1, TO, o) of the outermost circumferential track of the test area on the outer circumferential side of the L1 layer, the distances R3′, R4′ from the center of the L0 layer at the radial position R (0, G, i) of the innermost circumferential guide groove of the information-recording area of the L0 layer and the radial position R (0, G, o) of the outermost circumferential guide groove of the information-recording area of the L0 layer, the radius r of the laser beam on the L0 layer, and the eccentricity amount RRₚ₋ₚ. Therefore, in the case of the optical disk of Example 1 manufactured in accordance with the contents of the design as described above, the positional relationships of the physical formats between the L0 layer and the L1 layer satisfy the expressions (1) and (2). Therefore, in the case of the optical disk manufactured in Example 1, the light beam, which is collected over the entire region of the test area and the information-recording/reproducing area of the L1 layer, does not pass through the ROM area, the transition area, and the mirror area of the L0 layer in which the transmittance is fluctuated, and the light beam passes through only the information-recording area of the L0 layer in which the transmittance fluctuation is extremely small.

### COMPARATIVE EXAMPLE 1

In Comparative Example 1, an optical disk of the single-sided two-layered type was manufactured, in which both of the L0 layer and the L1 layer were formed with an identical track pitch, and the radial positions of the respective areas in the physical formats of the L0 layer and the L1 layer were identical as shown in Table 4. That is, the optical disk was manufactured, in which the expressions (1) and (2) were not satisfied by the positional relationships of the physical formats between the L0 layer and the L1 layer. The optical disk was constructed in the same manner as the optical disk of Example 1, and the optical disk was manufactured in accordance with the same method as that for the optical disk of Example 1 except that the track pitch of the L0 layer was the same as that of the L1 layer, and the radial positions of the respective areas in the physical formats of the L0 layer and the L1 layer were identical. The radial positions shown in Table 4 are the values at the designing stage. The numerical values shown in the columns of the L0 layer are the distances from the center of the L0 layer, and the numerical values shown in the columns of the L1 layer are the distances from the center of the L1 layer.

TABLE 4

| | L0 layer | | L1 layer | |
|---|---|---|---|---|
| | Start (mm) | End (mm) | Start (mm) | End (mm) |
| ROM area | 23.300 | 23.779 | 23.300 | 23.779 |
| Transition (mirror | 23.780 | 23.799 | 23.780 | 23.799 |
| surface) area | | | | |
| Buffer area | 23.800 | 23.809 | 23.800 | 23.809 |
| Test area | 23.810 | 23.999 | 23.810 | 23.999 |
| Information- | 24.000 | 57.921 | 24.000 | 57.921 |
| recording/ | | | | |
| reproducing area | | | | |
| Test area | 57.922 | 58.020 | 57.922 | 58.020 |
| Buffer area | 58.021 | 58.499 | 58.021 | 58.499 |
| Mirror surface area | 58.500 | | 58.500 | |

Recording Characteristics

Five of the optical disks of Example 1 and five of the optical disks of Comparative Example 1, which were of the single-sided two-layered type, were manufactured by way of trial. The recording was performed on the L0 layer, and then the recording was performed on the L1 layer. As a result, the recording was successfully performed normally on the L1 layer by one time of the recording operation for all of the five optical disks of Example 1. However, in the case of the optical disks of Comparative Example 1, the recording was successfully performed normally on the L1 layer by one time of the recording operation for one disk, the recording was successfully performed normally on the L1 layer after repeating the recording operation a plurality of times for three disks, and the recording was unsuccessful for the remaining one disk. According to this result, it has been revealed that information can be recorded and reproduced on the L1 layer stably and highly reliably by adjusting the positional relationship between the physical format of the L0 layer 10 and the physical format of the L1 layer 20 so that the relationships of the expressions (3) and (4) hold.

The test area on the inner circumferential side of the L1 layer was investigated for the optical disk for which the recording operation was retried and the optical disk for which the recording was unsuccessful, of the optical disks of Comparative Example 1. As a result, it has been revealed that the amplitude fluctuation of 1 cycle is caused per 1 round of the track. Such a situation arises because of the fact that the laser beam, which arrives at the test area on the inner circumferential side of the L1 layer, passes through the mirror surface area and the ROM area of the L0 layer due to the influence of the eccentricity caused when the L0 layer and the L1 layer are stuck to one another.

### EXAMPLE 2

In Example 2, an optical disk of the write-once type was manufactured, which was of the single-sided two-layered type, which was adapted to the blue laser, and which had a recording layer formed of a dye material. In the case of the optical disk of Example 2, there is such a possibility that the transmittance of the laser beam is fluctuated to some extent depending on the recording state of the test area of the information section (L0 layer) disposed on the side near to the light-incoming side when information is recorded and reproduced on the information section (L1 layer) disposed on the side far from the light-incoming side as explained with reference to Table 1 of Example 1, because the recording layer is formed of the dye material. Therefore, in the case of the optical disk of Example 2, this point is further taken into consideration. The physical formats of the respective information sections were adjusted so that the positional relationships of the physical formats between the L0 layer and the L1 layer satisfied the expressions (3) and (4). Further, the optical disk of Example 2 had the same film structure as the film structure shown in FIG. 1.

Production of Test Disk for Evaluating Transmittance and Measurement of Transmittance

At first, an explanation will be made about the relationship between the transmittance and the physical format of the L0 layer in the optical disk of the single-sided two-layered type which is adapted to the blue laser and which is based on the use of the dye material for the recording layer, in the same manner as in Example 1, before explaining details of the optical disk of Example 2. In order to investigate the relationship between the transmittance and the physical format of the L0 layer, a test disk of the single-sided two-layered type (hereinafter referred to as “transmittance-evaluating test disk” as well) was manufactured. Further, another test disk (hereinafter referred to as “reference test disk” as well) was also manufactured as a test disk to serve as the reference for the evaluation of the transmittance, in which a dummy substrate was stuck to the L1 layer in place of the L0 layer.

As shown in FIG. 7, the physical format of the L0 layer of the transmittance-evaluating test disk was composed of, from the inner circumferential side, a ROM area 91, a transition area 92, and an information-recording area 93 (including a buffer area, a test area, and an information-recording/reproducing area). Emboss pits were formed in an area on a substrate of the L0 layer corresponding to the ROM area 91, and a groove was formed in an area on the substrate corresponding to the information-recording area 93. An area on the substrate of the L0 layer corresponding to the transition area 92 was a mirror surface. Specifically, a pit array having a track pitch of 400 nm and a half value width of 160 nm was formed in the area on the substrate of the L0 layer corresponding to the ROM area 91 to record ROM data. A groove having a track pitch of 400 nm, a half value width of 220 nm, and a depth of 70 nm was formed in the area on the substrate corresponding to the information-recording area 93. The transition area 92 had a width in the radial direction of about 10 μm. On the other hand, a groove (guide groove) having a track pitch of 400 nm, a half value width of 220 nm, and a depth of 15 nm was formed from the innermost circumference to the outermost circumference of the transmittance-evaluating test disk on the surface of the substrate of the L1 layer of the disk. The film structure of the transmittance-evaluating test disk of Example 2 was constructed as shown in FIG. 1.

Next, an explanation will be made about a method for manufacturing the transmittance-evaluating test disk with reference to FIG. 1. The method for manufacturing the optical disk of the single-sided two-layered type of Example 2 is the same as the method for manufacturing the transmittance-evaluating test disk explained below.

At first, the L0 layer 10 was manufactured as follows. A stamper was manufactured, which was formed with a concave/convex pattern corresponding to the groove (guide groove) pattern and the pit array to be formed on the first substrate 11. Subsequently, the manufactured stamper was installed to an existing injection molding machine, and a polycarbonate resin of the grade for the optical information-recording medium was subjected to the injection molding to obtain the first substrate 11 of the L0 layer 10 of the test disk. In this case, the substrate made of polycarbonate having a diameter of 120 mm and a thickness of 0.6 mm was manufactured.

Subsequently, the surface of the first substrate 11, which was formed with the concave/convex pattern, was coated by the spin coat method with a tetrafluoropropanol solution having a concentration of 0.7% by weight of an azo-based dye represented by the following chemical formula (chemical formula 2). When the dye solution was subjected to the coating, the dye solution was filtrated through a filter to remove impurities. When the spin coat was performed, 0.5 g of the dye solution was supplied with a dispenser onto the first substrate 11 rotating at a number of revolutions of 100 rpm. After that, the first substrate 11 was rotated over a range from 1,000 rpm to 3,000 rpm, and the first substrate 11 was finally rotated for 2 seconds at 5,000 rpm. In this procedure, the solution was coated so that the thickness was 110 nm at the groove portion. Subsequently, the first substrate 11, on which the dye material had been coated, was dried at 80° C. for 1 hour, followed by being cooled at room temperature for 1 hour. Thus, the first recording layer 12 was formed on the first substrate 11.

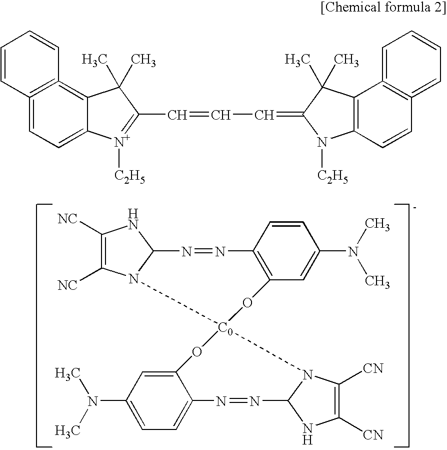

Further, an Ag film having a thickness of 10 nm was formed as the first reflective layer 13 on the first recording layer 12 by using the sputtering method. Thus, the L0 layer 10 was manufactured.

Subsequently, the L1 layer 20 was manufactured as follows. At first, the second substrate 21 of the L1 layer 20 was manufactured in the same manner as the first substrate 11 of the L0 layer 10. As for the L1 layer 20, the laser beam is radiated from the side of the second substrate 21 on which the groove pattern is formed. Therefore, considering this fact, the groove pattern was formed in a spiral form in a direction opposite to that of the L0 layer 10. In the case of the L1 layer 20, the respective constitutive films were formed in an order opposite to that of the L0 layer 10, on the groove pattern-formed surface of the second substrate 21.

At first, an Ag film having a thickness of 130 nm was formed as the second reflective layer 23 on the second substrate 21 by using the sputtering method. Subsequently, the surface of the second reflective layer 23 was coated by the spin coat method with a tetrafluoropropanol solution having a concentration of 0.7% by weight of the azo-based dye represented by the chemical formula described above (chemical formula 2) to form the second recording layer 22. In this procedure, the solution was coated under the same condition as that used for the formation of the first recording layer 12 of the L0 layer 10 as described above to form the second recording layer 22. The film thickness was 100 nm. The second substrate 21, to which the dye material had been coated as described above, was dried at 80° C. for 1 hour, followed by being cooled at room temperature for 1 hour. Subsequently, a ZnS—SiO₂ film having a film thickness of 10 nm was formed as the interface layer 24 on the second recording layer 22 by means of the sputtering method. Thus, the L1 layer 20 was formed.

Subsequently, the L0 layer 10 and the L1 layer 20, which had been manufactured as described-above, were stuck to one another as follows. At first, the surface of the first reflective layer 13 of the L0 layer 10 was coated by the spin coat method with a UV resin material as the spacer layer 30. Further, the L1 layer 20 was placed thereon. In this procedure, the L1 layer 20 was placed on the spacer layer 30 so that the first reflective layer 13 of the L0 layer 10 was opposed to the interface layer 24 of the L1 layer 20 with the spacer layer 30 intervening therebetween. Subsequently, the UV radiation was applied from the side of the first substrate 11 of the L0 layer 10 in this state. Accordingly, the UV resin material was cured to stick the L0 layer 10 and the L1 layer 20 to one another. It is preferable that the thickness of the spacer layer 30 is 15 to 25 μm. In Example 2, the thickness was 25 μm. The transmittance-evaluating test disk was manufactured as described above. The reference test disk was manufactured in accordance with the same method as that described above except that the dummy substrate was stuck to the L1 layer in place of the L0 layer.

The transmittance of the L0 layer was measured for the transmittance-evaluating test disk and the reference test disk prepared in accordance with the manufacturing method as described above. The transmittance of the L0 layer at the groove portion (information-recording area) was measured for the non-recorded state and the state after the recording. In this measurement, the following recording condition was adopted. That is, the linear velocity was 6.61 m/s, and the recording power was 9.0 mW. Results of the evaluation are shown in Table 5. The laser beam used for the measurement had a wavelength of 405 nm. The focusing lens had a numerical aperture of NA=0.65. The transmittance was measured by using a parallel light beam having a wavelength of 405 nm. The transmittance in the column of “absent” in Table 5 is the transmittance of the reference test disk.

TABLE 5

| | | Mirror | | Groove | Groove |
|---|---|---|---|---|---|
| | | surface | ROM | (not | (after |
| L0 layer | Absent | section | section | recorded) | recording) |
| Transmittance | 1.0 | 0.75 | 0.70 | 0.66 | 0.64 |

Further, the optimum value of the recording power for the L1 layer was investigated when the laser beam was radiated onto the L1 layer through the respective areas of the L0 layer. In this procedure, the strategy of the recording pulse was identical, and the recording power, with which the asymmetry was absent, was regarded as the optimum recording power. Obtained results are shown in Table 6. The optimum recording power in the column of “absent” in Table 6 is the optimum recording power of the reference test disk.

TABLE 6

| | | Mirror | | Groove | Groove |
|---|---|---|---|---|---|
| | | surface | ROM | (not | (after |
| L0 layer | Absent | section | section | recorded) | recording) |
| Optimum | 8.4 | 11.0 | 12.2 | 12.7 | 13.1 |
| recording | | | | | |
| power (mW) | | | | | |

As clarified from the results shown in Tables 5 and 6, it has been revealed that the transmittance of the L0 layer differs and the optimum recording power for the L1 layer changes as well depending on the shape of the first substrate of the L0 layer through which the light beam passes, with respect to the laser beam having the wavelength of 405 nm as well, in the same manner as in the results of the evaluation of the transmittance in Example 1, when the recording layer is formed of the dye material. Further, as clarified from Table 5, it has been revealed that the transmittance of the L0 layer is fluctuated to some extent depending on the recording state of the first recording layer as well. Therefore, it has been clarified that it is important to maintain the constant transmittance of the area of the L0 layer through which the light beam passes, for example, when information is recorded and reproduced by radiating the light beam onto the information-recording/reproducing area and the test area of the L1 layer.

Arrangement of Optical Disk of Example 2

In Example 2, the optical disk of the single-sided two-layered type was manufactured, in which both of the L0 layer and the L1 layer were formed with the physical format as shown in FIG. 2, and the positional relationships of the physical formats between the L0 layer and the L1 layer was the relationships as shown in Table 7. Table 7 also shows the start radial position and the end radial position of each of the areas for constructing the physical formats of the L0 layer and the L1 layer. The radial positions shown in Table 7 are the values at the designing stage. The numerical values shown in the columns of the L0 layer are the distances from the center of the L0 layer, and the numerical values shown in the columns of the L1 layer are the distances from the center of the L1 layer.

TABLE 7

| | L0 layer | | L1 layer | |
|---|---|---|---|---|
| | Start (mm) | End (mm) | Start (mm) | End (mm) |
| ROM area | 23.300 | 23.779 | 23.300 | 23.779 |
| Transition (mirror | 23.780 | 23.799 | 23.780 | 23.799 |
| surface) area | | | | |
| Buffer area | 23.800 | 23.809 | 23.800 | 24.063 |
| Test area | 23.810 | 23.999 | 24.064 | 24.251 |
| Information- | 24.000 | 57.921 | 24.252 | 57.759 |
| recording/ | | | | |
| reproducing area | | | | |
| Test area | 57.922 | 58.020 | 57.760 | 57.857 |
| Buffer area | 58.021 | 58.499 | 57.858 | 58.499 |
| Mirror surface area | 58.500 | | 58.500 | |

In the optical disk of Example 2, the track pitch of the L1 layer was narrower than the track pitch of the L0 layer in order that the number of tracks of the L1 layer was the same as the number of tracks of the L0 layer, i.e., in order that the recording capacity of the L0 layer was the same as the recording capacity of the L1 layer and in order that the start radial positions and the end radial positions of the respective areas were adjusted. Specifically, the track pitch of the L0 was 400 nm, and the track pitch of the L1 layer was 395 nm. The groove, which was formed in the area on the first substrate corresponding to the information-recording area of the L0 layer of the optical disk of Example 2, had the dimension which was the same as the dimension (track pitch: 400 nm, half value width: 220 nm, depth: 70 nm) of the transmittance-evaluating test disk. The groove, which was formed in the area on the second substrate corresponding to the information-recording area of the L1 layer, had the dimension in which the track pitch was 395 nm, the half value width was 218 nm, and the depth was 15 nm.

The optical disk of Example 2 had the same structure as that of the transmittance-evaluating test disk described above except that the physical format arrangement of the L0 layer was the same as that of the L1 layer, the radial positions of the respective areas in the physical formats of the L0 layer and the L1 layer were adjusted as shown in Table 7, and the track pitch was changed for the L1 layer and the L0 layer. The optical disk of Example 2 was manufactured in accordance with the same method as that for the transmittance-evaluating test disk described above.

As clarified by the results of the measurement of the transmittance described above (results shown in Table 5), the transmittance is also fluctuated depending on the recording state of the recording layer when the dye material is used for the recording layer of the L0 layer. Therefore, in the case of the optical disk of Example 2, the positional relationships of the respective areas in the physical formats of the L0 layer and the L1 layer were adjusted so that the light beam, which was collected over the entire region of the test area and the information-recording/reproducing area of the L1 layer, did not pass through the ROM area, the transition area, the mirror area, and the test area of the L0 layer in which the transmittance was fluctuated, and the light beam passed through only the area (information-recording/reproducing area 55 shown in FIG. 2) of the L0 layer in which information (write-once information such as the user information) was recorded and in which the transmittance was scarcely fluctuated.

In the case of the optical disk of Example 2, as clarified from Table 7, the following values are obtained at the designing stage. That is, the distance from the center of the L1 layer at the radial position R (1, TI, i) of the innermost circumferential track of the test area on the inner circumferential side of the L1 layer is R1′=24.064 mm. The distance from the center of the L1 layer at the radial position R (1, TO, o) of the outermost circumferential track of the test area on the outer circumferential side of the L1 layer is R2′=57.857 mm. The distance from the center of the L0 layer at the radial position R (0, D, i) of the innermost circumferential track of the information-recording/reproducing area of the L0 layer is R5′=24.000 mm. The distance from the center of the L0 layer at the radial position R (0, D, o) of the outermost circumferential track of the information-recording/reproducing area of the L0 layer is R6′=57.921 mm. When the optical disk of Example 2 was subjected to the recording and reproduction, then the laser beam having a wavelength of 405 nm was used, and the lens having a numerical aperture NA=0.65 was used for the focusing lens. The spacer layer of the optical disk was formed of a material having a refractive index ns=1.5 at the wavelength 405 nm, and the thickness D thereof was 25 μm. Therefore, in the case of the optical disk of Example 2, the radius r of the laser beam on the L0 layer was about 11.5 μm when the laser beam was collected on the L1 layer. In Example 2, the specification value RRₚ₋ₚ of the eccentricity amount upon the stacking of the L0 layer and the L1 layer was 50 μm.

Therefore, in the case of the optical disk of Example 2, the relationships of the expressions (3)′ and (4), hold at the designing stage in relation to the distances R1′, R2′ from the center of the L1 layer at the radial position R (1, TI, i) of the innermost circumferential track of the test area on the inner circumferential side of the L1 layer and the radial position R (1, TO, o) of the outermost circumferential track of the test area on the outer circumferential side of the L1 layer, the distances R5′, R6′ from the center of the L0 layer at the radial position R (0, D, i) of the innermost circumferential track of the information-recording/reproducing area of the L0 layer and the radial position R (0, D, o) of the outermost circumferential track of the information-recording/reproducing area of the L0 layer, the radius r of the laser beam on the L0 layer, and the specification value RRₚ₋ₚ of the eccentricity amount. Therefore, in the case of the optical disk of Example 2 manufactured in accordance with the contents of the design as described above, the positional relationships of the physical formats between the L0 layer and the L1 layer satisfy the expressions (3) and (4). Therefore, in the case of the optical disk manufactured in Example 2, the light beam, which is collected over the entire region of the test area and the information-recording/reproducing area of the L1 layer, does not pass through the ROM area, the transition area, the mirror area, and the test area of the L0 layer in which the transmittance is fluctuated, and the light beam passes through only the information-recording/reproducing area of the L0 layer in which the transmittance fluctuation is extremely small.

### COMPARATIVE EXAMPLE 2

In Comparative Example 2, an optical disk of the single-sided two-layered type was manufactured, in which both of the L0 layer and the L1 layer were formed with an identical track pitch, and the radial positions of the respective areas in the physical formats of the L0 layer and the L1 layer were identical as shown in Table 8. That is, the optical disk was manufactured, in which the expressions (3) and (4) were not satisfied by the positional relationships of the physical formats between the L0 layer and the L1 layer. The optical disk was constructed in the same manner as the optical disk of Example 2, and the optical disk was manufactured in accordance with the same method as that for the optical disk of Example 2 except that the track pitch of the L0 layer was the same as that of the L1 layer, and the radial positions of the respective areas in the physical formats of the L0 layer and the L1 layer were identical. The radial positions shown in Table 8 are the values at the designing stage. The numerical values shown in the columns of the L0 layer are the distances from the center of the L0 layer, and the numerical values shown in the columns of the L1 layer are the distances from the center of the L1 layer.

TABLE 8

| | L0 layer | | L1 layer | |
|---|---|---|---|---|
| | Start (mm) | End (mm) | Start (mm) | End (mm) |
| ROM area | 23.300 | 23.779 | 23.300 | 23.779 |
| Transition (mirror | 23.780 | 23.799 | 23.780 | 23.799 |
| surface) area | | | | |
| Buffer area | 23.800 | 23.809 | 23.800 | 23.809 |
| Test area | 23.810 | 23.999 | 23.810 | 23.999 |
| Information- | 24.000 | 57.921 | 24.000 | 57.921 |
| recording/ | | | | |
| reproducing area | | | | |
| Test area | 57.922 | 58.020 | 57.922 | 58.020 |
| Buffer area | 58.021 | 58.499 | 58.021 | 58.499 |
| Mirror surface area | 58.500 | | 58.500 | |

Recording Characteristics

Five of the optical disks of Example 2 and five of the optical disks of Comparative Example 2, which were of the single-sided two-layered type, were manufactured by way of trial. The recording was performed on the L0 layer, and then the recording was performed on the L1 layer. As a result, the recording was successfully performed normally on the L1 layer by one time of the recording operation for all of the five optical disks of Example 2. However, in the case of the optical disks of Comparative Example 2, the recording was successfully performed normally on the L1 layer by one time of the recording operation for one disk, the recording was successfully performed normally on the L1 layer after repeating the recording operation a plurality of times for three disks, and the recording was unsuccessful for the remaining one disk. According to this result, it has been revealed that information can be recorded and reproduced on the L1 layer stably and highly reliably by adjusting the positional relationship between the physical format of the L0 layer 10 and the physical format of the L1 layer 20 so that the relationships of the expressions (3) and (4) hold.

The test area on the inner circumferential side of the L1 layer was investigated for the optical disk for which the recording operation was retried and the optical disk for which the recording was unsuccessful, of the optical disks of Comparative Example 2. As a result, it has been revealed that the amplitude fluctuation of 1 cycle is caused per 1 round of the track. Such a situation arises because of the fact that the laser beam, which arrives at the test area on the inner circumferential side of the L1 layer, passes through the mirror surface area and the ROM area of the L0 layer due to the influence of the eccentricity caused when the L0 layer and the L1 layer are stuck to one another.

### EXAMPLE 3

In Example 3, an optical disk of the rewritable type was manufactured, which was of the single-sided two-layered type, which was adapted to the blue laser, and which had a recording layer formed of a phase-change material. In the case of the optical disk of Example 3, the transmittance of the laser beam is fluctuated depending on the shape of the substrate of the information section (L0 layer) disposed on the side near to the light-incoming side but the transmittance of the laser beam is scarcely fluctuated depending on the recording state of the test area when information is recorded and reproduced on the information section (L1 layer) disposed on the side far from the light-incoming side as described later on, because the recording layer is formed of the phase-change material. Therefore, in the case of the optical disk of Example 3, the physical formats of the respective information sections were adjusted so that the positional relationships of the physical formats between the L0 layer and the L1 layer satisfied the expressions (1) and (2).

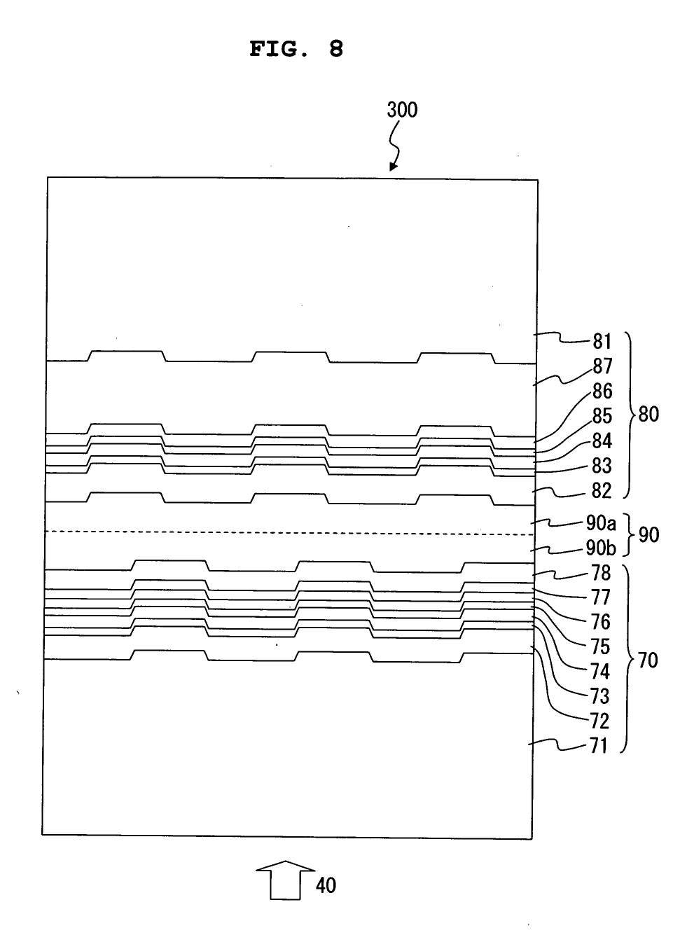

FIG. 8 shows a schematic sectional view illustrating the rewritable type optical disk of the single-sided two-layered type manufactured in Example 3. As shown in FIG. 8, the optical disk 300 of Example 3 has such a structure that an L0 layer 70 (first information section) and an L1 layer 80 (second information section) are stuck to one another with a spacer layer 90 intervening therebetween.

As shown in FIG. 8, the L0 layer 70 has such a structure that a first protective layer 72, a first interface layer 73, a first recording layer 74, a second interface layer 75, a second protective layer 76, a first reflective layer 77, and a third protective layer 78 are successively stacked on a first substrate 71. As shown in FIG. 8, the L1 layer 80 has such a structure that a second reflective layer 87, a second protective layer 86, a second interface layer 85, a second recording layer 84, a first interface layer 83, and a first protective layer 82 are successively stacked on a second substrate 81. The L0 layer 70 and the L1 layer 80 are stuck to one another with the spacer layer 90 intervening therebetween so that the third protective layer 78 of the L0 layer 70 is opposed to the first protective layer 82 of the L1 layer 80. In Example 3, as shown in FIG. 8, the laser beam 40 comes from the side of the first substrate 71 of the L0 layer 70.

Production of Test Disk for Evaluating Transmittance and Measurement of Transmittance

At first, an explanation will be made about the relationship between the transmittance and the physical format of the L0 layer in the optical disk of the single-sided two-layered type which is adapted to the blue laser and which is based on the use of the phase-change material for the recording layer in Example 3 as well, before explaining details of the optical disk of Example 3. In order to investigate the relationship between the transmittance and the physical format of the L0 layer, a test disk of the single-sided two-layered type (hereinafter referred to as “transmittance-evaluating test disk” as well) was manufactured. Further, another test disk (hereinafter referred to as “reference test disk” as well) was also manufactured as a test disk to serve as the reference for the evaluation of the transmittance, in which a dummy substrate was stuck to the L1 layer in place of the L0 layer. The film structure of the transmittance-evaluating test disk was the film structure shown in FIG. 8.

An explanation will be made below with reference to FIG. 8 about a method for manufacturing the transmittance-evaluating test disk. The method for manufacturing the rewritable type optical disk of the single-sided two-layered type of Example 3 is the same as the method for manufacturing the transmittance-evaluating test disk described below.

At first, the L0 layer 70 was manufactured as follows. A substrate made of polycarbonate having a diameter of 120 mm and a thickness of 0.6 mm was used for the first substrate 71 of the L0 layer 70. As shown in FIG. 7, the physical format of the L0 layer 70 was constructed to include the ROM area 91, the transition area 92, and the information-recording area 93 disposed in this order from the inner circumferential side. Emboss pits were formed in an area on the first substrate 71 of the L0 layer corresponding to the ROM area 91, and a groove was formed in an area on the first substrate 71 corresponding to the information-recording area 93. An area on the first substrate 71 corresponding to the transition area 92 was a mirror surface. Specifically, a pit array having a track pitch of 400 nm and a half value width of 160 nm was formed in the area on the substrate 71 of the L0 layer corresponding to the ROM area 91. A groove having a track pitch of 400 nm, a half value width of 220 nm, and a depth of 20 nm was formed in the area on the first substrate 71 corresponding to the information-recording area 93. The area on the first substrate 71 corresponding to the transition area 92 was formed with a mirror surface having a width of about 10 μm in the radial direction. The concave/convex pattern on the first substrate 71 as described above was formed by using a stamper in the same manner as in Example 1.

Subsequently, the first protective layer 72, the first interface layer 73, the first recording layer 74, the second interface layer 75, the second protective layer 76, the first reflective layer 77, and the third protective layer 78 were successively stacked on the first substrate 71 of the L0 layer 70 by means of the sputtering process. In this procedure, the first protective layer 72 was formed of (ZnS)₈₀(SiO₂)₂₀ having a film thickness of 50 nm. The first interface layer 73 was formed of Ge₈Cr₂-N having a film thickness of 1 nm. The first recording layer 74 was formed of Bi_{4.5}Ge₄₈Te_{47.5} having a film thickness of 7 nm. The second interface layer 75 was formed of Ge₈Cr₂-N having a film thickness of 2 nm. The second protective layer 76 was formed of (ZnS)₈₀ (SiO₂)₂₀ having a film thickness of 7 nm. The first reflective layer 77 was formed of Ag having a film thickness of 8 nm. The third protective layer 78 was formed of (ZnS)₈₀(SiO₂)₂₀ having a film thickness of 25 nm.

The single plate disk of the L0 layer 70 manufactured as described above was irradiated with a laser beam which had a wavelength of 810 nm and which had an elliptical beam having a beam major axis of 96 μm and a minor axis of 1 μm to perform the initialization. Thus, the L0 layer 70 was manufactured.

Subsequently, the L1 layer 80 was manufactured as follows. At first, a substrate made of polycarbonate having a diameter of 120 mm and a thickness of 0.6 mm was used for the second substrate 81 of the L1 layer 80. A groove (guide groove) having a track pitch of 400 nm, a half value width of 180 nm, and a depth of 20 nm was formed over a range from the innermost circumference to the outermost circumference of the disk on the surface of the second substrate 81. As shown in FIG. 8, the laser beam 40 is radiated onto the L1 layer 80 from the side of the surface on which the groove pattern of the second substrate 81 is formed. Therefore, taking this fact into consideration, the groove pattern was formed in a spiral in a direction opposite to that of the L0 layer 70.

Subsequently, the second reflective layer 87, the second protective layer 86, the second interface layer 85, the second recording layer 84, the first interface layer 83, and the first protective layer 82 were successively stacked by means of the sputtering process on the surface of the second substrate 81 of the L1 layer 80 on which the groove pattern was formed. That is, the respective constitutive films of the L1 layer 80 were formed for the L1 layer 80 in the order opposite to the stacking order of the constitutive films of the L0 layer 70. In this procedure, the second reflective layer 87 was formed of Ag having a film thickness of 150 nm. The second protective layer 86 was formed of (ZnS)₈₀(SiO₂)₂₀ having a film thickness of 11 nm. The second interface layer 85 was formed of Ge₈Cr₂-N having a film thickness of 2 nm. The second recording layer 84 was formed of Bi_{4.5}Ge_{4.5}Te_{47.5} having a film thickness of 11 nm. The first interface layer 83 was formed of Ge₈Cr₂-N having a film thickness of 7 nm. The first protective layer 82 was formed of (ZnS)₈₀(SiO₂)₂₀ having a film thickness of 60 nm. Thus, the L1 layer 80 was manufactured.

Subsequently, the surface of the first protective layer 82 of the L1 layer 80 was coated with a UV resin material by means of the spin coat method. The UV irradiation was applied in this state to cure the UV resin material, and thus a UV resin layer 90a as a part of the spacer layer 90 was formed. The UV resin layer 90a had a film thickness of 10 μm. Subsequently, the single plate disk of the L1 layer 80 formed with the UV resin layer 90a was irradiated with a laser beam which had a wavelength of 810 nm and which had an elliptical beam having a beam major axis of 96 μm and a minor axis of 1 μm to perform the initialization in the same manner as in the L0 layer 70. In this procedure, the apparatus used for the initialization was dealt with such that an optical glass having a thickness of 0.6 mm was inserted between the single plate disk described above and the optical head for radiating the laser beam to correct the spherical aberration.

Subsequently, the L0 layer 70 and the L1 layer 80 manufactured by the method as described above were stuck to one another as follows. At first, a UV resin material was coated by means of the spin coat method onto the third protective layer 78 of the L0 layer 70 to form a UV resin layer 90b. The L1 layer 80 was further placed thereon. In this procedure, as shown in FIG. 8, the L1 layer 80 was placed so that the third protective layer 78 of the L0 layer 70 was opposed to the first protective layer 82 of the L1 layer 80 with the spacer layer 90 intervening therebetween. The UV irradiation was applied from the side of the L0 layer 70 in this state. Accordingly, the UV resin material of the UV resin layer 90b was cured to form the spacer layer 90, and the L0 layer 70 and the L1 layer 80 were stuck to one another. It is preferable that the thickness of the spacer layer 90 is 15 to 25 μm. In Example 3, the thickness was 25 μm. The spacer layer 90 was formed of the resin having a refractive index of 1.50 at a wavelength of 405 nm. The transmittance-evaluating test disk of Example 3 was manufactured as described above. The reference test disk was manufactured in accordance with the same method as that described above except that a dummy substrate was stuck to the L1 layer in place of the L0 layer.

The transmittance of the L0 layer was measured for the transmittance-evaluating test disk and the reference test disk prepared in accordance with the manufacturing method as described above. The transmittance of the L0 layer at the groove portion (information-recording area) was measured in the erased state and the recorded state. In this procedure, the following recording condition was adopted. That is, the linear velocity was 6.61 m/s, the recording power was 8.5 mW, and the erasing power was 4.0 mW. Results of the evaluation are shown in Table 9. The laser beam used for the measurement had a wavelength of 405 nm. The light-collecting objective lens had a numerical aperture of NA=0.65. The transmittance was measured by using a parallel light beam having a wavelength of 405 nm. The transmittance in the column of “absent” in Table 9 is the transmittance of the reference test disk.

TABLE 9

| | | Mirror | | Groove | Groove |
|---|---|---|---|---|---|
| | | surface | ROM | (erased | (recorded |
| L0 layer | Absent | section | section | state) | state) |
| Transmittance | 1.0 | 0.61 | 0.55 | 0.50 | 0.50 |

Further, the optimum values of the recording power and the erasing power for the L1 layer were investigated when the laser beam was radiated onto the L1 layer through the respective areas of the L0 layer. In this procedure, the strategy of the recording pulse was identical, and the recording power and the erasing power, with which the asymmetry was absent, were regarded as the optimum values respectively. Obtained results are shown in Table 10. The optimum recording power and the optimum erasing power in the columns of “absent” in Table 10 are the optimum recording power and the optimum erasing power of the reference test disk.

TABLE 10

| | | Mirror | | Groove | Groove |
|---|---|---|---|---|---|
| | | surface | ROM | (erased | (recorded |
| L0 layer | Absent | section | section | state) | state) |
| Optimum | 6.6 | 10.8 | 11.9 | 13.0 | 13.1 |
| recording | | | | | |
| power (mW) | | | | | |
| Optimum | 3.3 | 5.5 | 6.0 | 6.6 | 6.5 |
| erasing | | | | | |
| power (mW) | | | | | |

As clarified from the results shown in Tables 9 and 10, the following fact has been revealed. That is, the transmittance of the L0 layer is not changed depending on the recording state of the first recording layer of the L0 layer when the recording layer is formed of the phase-change material. However, the transmittance of the L0 layer differs and the optimum recording power and the reproducing power change as well depending on the shape of the first substrate of the L0 layer. Therefore, also in Example 3, it has been clarified that it is important to maintain the constant transmittance of the area of the L0 layer through which the light beam passes, for example, when information is recorded and reproduced by radiating the light beam onto the information-recording/reproducing area and the test area of the L1 layer.

Arrangement of Optical Disk of Example 3

In Example 3, the rewritable type optical disk of the single-sided two-layered type was manufactured, in which both of the L0 layer and the L1 layer were formed with the physical format as shown in FIG. 2, and the positional relationships of the physical formats between the L0 layer and the L1 layer was the relationships as shown in Table 11. Table 11 also shows the start radial position and the end radial position of each of the areas for constructing the physical formats of the L0 layer and the L1 layer. The radial positions shown in Table 11 are the values at the designing stage. The numerical values shown in the columns of the L0 layer are the distances from the center of the L0 layer, and the numerical values shown in the columns of the L1 layer are the distances from the center of the L1 layer.

TABLE 11

| | L0 layer | | L1 layer | |
|---|---|---|---|---|
| | Start (mm) | End (mm) | Start (mm) | End (mm) |
| ROM area | 23.300 | 23.779 | 23.300 | 23.779 |
| Transition (mirror | 23.780 | 23.799 | 23.780 | 23.799 |
| surface) area | | | | |
| Buffer area | 23.800 | 23.809 | 23.800 | 24.869 |
| Test area | 23.810 | 23.999 | 23.870 | 24.059 |
| Information- | 24.000 | 57.921 | 24.060 | 57.981 |
| recording/ | | | | |
| reproducing area | | | | |
| Test area | 57.922 | 58.020 | 57.982 | 58.080 |
| Buffer area | 58.021 | 58.499 | 58.081 | 58.499 |
| Mirror surface area | 58.500 | | 58.500 | |

In the optical disk of Example 3, the positional arrangement of the information-recording/reproducing area of the L1 layer was the arrangement deviated to the outer circumferential side as compared with the information-recording/reproducing area of the L0 layer in order that the number of tracks of the L1 layer was the same as the number of tracks of the L0 layer, i.e., in order that the recording capacity of the L0 layer was the same as the recording capacity of the L1 layer. The groove, which was formed in the area on the first substrate corresponding to the information-recording area of the L0 layer of the optical disk of Example 3, had the dimension which was the same as the dimension (track pitch: 400 nm, half value width: 220 nm, depth: 20 nm) of the transmittance-evaluating test disk. The groove, which was formed in the area on the second substrate corresponding to the information-recording area of the L1 layer, had the dimension in which the track pitch was 400 nm, the half value width was 180 nm, and the depth was 20 nm.

The optical disk of Example 3 had the same structure as that of the transmittance-evaluating test disk described above except that the physical format arrangement of the L0 layer was the same as that of the L1 layer, the radial positions of the respective areas in the physical formats of the L0 layer and the L1 layer were adjusted as shown in Table 11, and the track pitch was changed for the L1 layer and the L0 layer. The optical disk of Example 3 was manufactured in accordance with the same method as that for the transmittance-evaluating test disk described above.

As clarified by the results of the measurement of the transmittance described above (results shown in Table 9), the transmittance is fluctuated in the ROM area, the transition area, and the mirror area of the L0 layer when the phase-change material is used for the recording layer. Therefore, in the case of the optical disk of Example 3, the positional relationships of the respective areas in the physical formats of the L0 layer and the L1 layer were adjusted so that the light beam, which was collected over the entire region of the test area and the information-recording/reproducing area of the L1 layer, did not pass through the ROM area, the transition area, and the mirror area of the L0 layer in which the transmittance was fluctuated, and the light beam passed through only the area (information-recording area 50 shown in FIG. 2) of the L0 layer in which the groove was formed and in which the transmittance was scarcely fluctuated.

In the case of the optical disk of Example 3, as clarified from Table 11, the following values are obtained at the designing stage. That is, the distance from the center of the L1 layer at the radial position R (1, TI, i) of the innermost circumferential track of the test area on the inner circumferential side of the L1 layer is R1′=23.870 mm. The distance from the center of the L1 layer at the radial position R (1, TO, o) of the outermost circumferential track of the test area on the outer circumferential side of the L1 layer is R2′=58.080 mm. The distance from the center of the L0 layer at the radial position R (0, G, i) of the innermost circumferential guide groove of the information-recording area of the L0 layer is R3′=23.800 mm. The distance from the center of the L0 layer at the radial position R (0, G, o) of the outermost guide groove of the information-recording area of the L0 layer is R4′=58.499 mm. When the optical disk of Example 3 was subjected to the recording and reproduction, then the laser beam having a wavelength of 405 nm was used, and the lens having a numerical aperture NA=0.65 was used for the focusing lens. The spacer layer of the optical disk was formed of a material having a refractive index ns=1.5 at the wavelength 405 nm, and the thickness D thereof was 25 μm. Therefore, in the case of the optical disk of Example 3, the radius r of the laser beam on the L0 layer was about 11.5 μm when the laser beam was collected on the L1 layer. In Example 3, the specification value RRₚ₋ₚ of the eccentricity amount upon the stacking of the L0 layer and the L1 layer was 50 μm.

Therefore, in the case of the optical disk of Example 3, the relationships of the expressions (1)′ and (2)′ hold at the designing stage in relation to the distances R1′, R2′ from the center of the L1 layer at the radial position R (1, TI, i) of the innermost circumferential track of the test area on the inner circumferential side of the L1 layer and the radial position R (1, TO, o) of the outermost circumferential track of the test area on the outer circumferential side of the L1 layer, the distances R3′, R4′ from the center of the L0 layer at the radial position R (0, G, i) of the innermost circumferential guide groove of the information-recording area of the L0 layer and the radial position R (0, G, o) of the outermost circumferential guide groove of the information-recording area of the L0 layer, the radius r of the laser beam on the L0 layer, and the specification value RRₚ₋ₚ of the eccentricity amount. Therefore, in the case of the optical disk of Example 3 manufactured in accordance with the contents of the design as described above, the positional relationships of the physical formats between the L0 layer and the L1 layer satisfy the expressions (1) and (2). Therefore, in the case of the optical disk manufactured in Example 3, the light beam, which is collected over the entire region of the test area and the information-recording/reproducing area of the L1 layer, does not pass through the ROM area, the transition area, and the mirror area of the L0 layer in which the transmittance is fluctuated, and the light beam passes through only the information-recording area of the L0 layer in which the transmittance fluctuation is extremely small.

### COMPARATIVE EXAMPLE 3

In Comparative Example 3, a rewritable type optical disk of the single-sided two-layered type was manufactured, in which both of the L0 layer and the L1 layer were formed with an identical track pitch, and the radial positions of the respective areas in the physical formats of the L0 layer and the L1 layer were identical as shown in Table 8. That is, the optical disk was manufactured, in which the expressions (1) and (2) were not satisfied by the positional relationships of the physical formats between the L0 layer and the L1 layer. The optical disk was constructed in the same manner as the optical disk of Example 3, and the optical disk was manufactured in accordance with the same method as that for the optical disk of Example 3 except that the track pitch of the L0 layer was the same as that of the L1 layer, and the radial positions of the respective areas in the physical formats of the L0 layer and the L1 layer were identical.

Recording Characteristics

Five of the optical disks of Example 3 and five of the optical disks of Comparative Example 3, which were of the rewritable type and of the single-sided two-layered type, were manufactured by way of trial. The recording was performed on the L0 layer, and then the recording was performed on the L1 layer. As a result, the recording was successfully performed normally on the L1 layer by one time of the recording operation for all of the five optical disks of Example 3. However, in the case of the optical disks of Comparative Example 3, the recording was successfully performed normally on the L1 layer by one time of the recording operation for none of the five disks, the recording was successfully performed normally on the L1 layer after repeating the recording operation a plurality of times for two disks, and the recording was unsuccessful for the remaining three disks. According to this result, it has been revealed that information can be recorded and reproduced on the L1 layer stably and highly reliably by adjusting the positional relationship between the physical format of the L0 layer 10 and the physical format of the L1 layer 20 so that the relationships of the expressions (1) and (2) hold.

The test area on the inner circumferential side of the L1 layer was investigated for all of the optical disks of Comparative Example 3. As a result, it has been revealed that the amplitude fluctuation of 1 cycle is caused per 1 round of the track. Such a situation arises because of the fact that the laser beam, which arrives at the test area on the inner circumferential side of the L1 layer, passes through the mirror surface area and the ROM area of the L0 layer due to the influence of the eccentricity caused when the L0 layer and the L1 layer are stuck to one another.

In Examples 1 to 3 described above, the optical recording media, each of which is provided with the two information sections, have been explained. However, the present invention is not limited thereto. The present invention is also applicable to an optical recording medium which is provided with three or more information sections. When the optical recording medium is provided with three or more information sections, it is assumed that one information section, which is included in the respective adjoining information sections and which is disposed on the side to allow the light beam to come, is designated as the first information section, and the other information section is designated as the second information section. On this assumption, it is appropriate to adjust the positional relationships of the physical formats of the respective information sections so that the expression (1) (or the expression (3)) holds when the test area is provided in the vicinity of the inner circumference of the second information-recording area, the expression (2) (or the expression (4)) holds when the test area is provided in the vicinity of the outer circumference of the second information-recording area, and the expressions (1) and (2) (or the expressions (3) and (4)) hold when the test areas are provided in the vicinity of the both of the inner circumference and the outer circumference of the second information-recording area.

As described above, in the case of the optical recording medium of the present invention, information can be recorded and reproduced stably and highly reliably on the information section (second information section) disposed on the side far from the light-incoming side as well. Therefore, the optical recording medium of the present invention is preferably usable as the optical recording medium having two or more recording layers for recording and reproducing information by allowing the light beam to come from one side. In particular, the optical recording medium of the present invention is preferably usable as the optical disk of the single-sided two-layered type.

What is claimed is:

1. An optical recording medium on which information is recorded and reproduced by being irradiated with a light beam, the optical recording medium comprising:
a first information section which includes a first substrate and a first recording layer and into which the light beam comes from a side of the first substrate; and
a second information section which includes a second substrate and a second recording layer and in which the second recording layer is arranged on a side of the first recording layer of the first information section, wherein:
the first information section has a first preformat area and a first information-recording area, emboss pits are provided in an area on the first substrate corresponding to the first preformat area, and a guide groove for the light beam is provided in an area on the first substrate corresponding to the first information-recording area;
the second information section has a second information-recording area and a test area which is included in at least one of a portion disposed in the vicinity of an inner circumference and a portion disposed in the vicinity of an outer circumference in the second information-recording area and which is usable to determine a recording condition when information is recorded, and a guide groove for the light beam is provided in an area on the second substrate corresponding to the second information-recording area; and
an area of the first information section which corresponds to the test area of the second information section is included in the first information-recording area of the first information section.

2. The optical recording medium according to claim 1, wherein:
the following expression (1) holds when the test area is provided at the portion disposed in the vicinity of the inner circumference of the second information-recording area:
R1≧R3+r (1); and
the following expression (2) holds when the test area is provided at the portion disposed in the vicinity of the outer circumference of the second information-recording area:
R2≦R4−r (2)
wherein R1, R2, R3, and R4 represent distances from a center of the optical recording medium at a radial position of an innermost circumferential track of the test area when the test area is provided at the portion in the vicinity of the inner circumference of the second information-recording area, a radial position of an outermost circumferential track of the test area when the test area is provided at the portion in the vicinity of the outer circumference of the second information-recording area, a radial position of an innermost circumferential guide groove of the first information-recording area, and a radial position of an outermost circumferential guide groove of the first information-recording area respectively, and r represents a radius of the light beam on the first information section when the light beam is collected on the second information section.

3. The optical recording medium according to claim 2, wherein the test area is provided at each of the portions disposed in the vicinity of the inner circumference and the outer circumference of the second information-recording area, and both of the expressions (1) and (2) hold.

4. The optical recording medium according to claim 2, further comprising a spacer layer which is disposed between the first information section and the second information section.

5. The optical recording medium according to claim 2, wherein a track pitch of the first information section has a size which is not less than that of a track pitch of the second information section.

6. The optical recording medium according to claim 5, wherein a recording capacity of the first information section is same as a recording capacity of the second information section.

7. The optical recording medium according to claim 2, wherein the first information section has a first transition area which is disposed between the first preformat area and the first information-recording area.

8. The optical recording medium according to claim 7, wherein an area on the first substrate, which corresponds to the first transition area, is a mirror surface.

9. The optical recording medium according to claim 2, wherein the second information section further includes a second preformat area, and a second transition area which is provided between the second preformat area and the second information-recording area, and emboss pits are provided in an area on the second substrate corresponding to the second preformat area.

10. The optical recording medium according to claim 7, wherein the first transition area of the first information section and the test area of the second information section are disposed in different areas.

11. The optical recording medium according to claim 2, wherein each of the first and second recording layers is formed of an organic dye material.

12. The optical recording medium according to claim 2, wherein each of the first and second recording layers is formed of a phase-change material.

13. The optical recording medium according to claim 2, wherein:
the following expression (3) holds when the test area is provided at the portion disposed in the vicinity of the inner circumference of the second information-recording area:
R1≧R5+r (3); and
the following expression (4) holds when the test area is provided at the portion disposed in the vicinity of the outer circumference of the second information-recording area:
R2≦R6−r (4)
wherein R5 and R6 represent distances from the center of the optical recording medium at a radial position of an innermost circumferential track on which information is recorded in the first information-recording area, and a radial position of an outermost circumferential track on which information is recorded in the first information-recording area respectively.

14. The optical recording medium according to claim 13, wherein the test area is provided at each of the portions disposed in the vicinity of the inner circumference and the outer circumference of the second information-recording area, and both of the expressions (3) and (4) hold.

15. The optical recording medium according to claim 13, further comprising a spacer layer which is disposed between the first information section and the second information section.

16. The optical recording medium according to claim 13, wherein a track pitch of the first information section has a size which is not less than that of a track pitch of the second information section.

17. The optical recording medium according to claim 16, wherein a recording capacity of the first information section is same as a recording capacity of the second information section.

18. The optical recording medium according to claim 13, wherein the first information section has a first transition area which is disposed between the first preformat area and the first information-recording area.

19. The optical recording medium according to claim 18, wherein an area of the first substrate, which corresponds to the first transition area, is a mirror surface.

20. The optical recording medium according to claim 13, wherein the second information section further includes a second preformat area, and a second transition area which is provided between the second preformat area and the second information-recording area, and emboss pits are provided in an area on the second substrate corresponding to the second preformat area.
